(19) United States
(12) Patent Application Publication
(10) Pub. No.: US 2011/0166886 A1
(43) Pub. Date: Jul. 7, 2011

(54) Bariatric Treatment Management System and Method

(76) Inventors: Vincent Zeringue, Del Mar, CA (US); Pamela J. Maino, New York, NY (US); Eric Jakel, Noblesville, IN (US); David TenBarge, Peapack, NJ (US); George Ludlow, Mendham, NJ (US)

(21) Appl. No.: 12/951,096

(22) Filed: Nov. 22, 2010

Related U.S. Application Data
(60) Provisional application No. 61/281,963, filed on Nov. 24, 2009.

(51) Int. Cl. G06Q 50/00; G06Q 10/00

(52) U.S. Cl. 705/3

(57) ABSTRACT

Disclosed is a computer-implemented method for managing a medical practice. The disclosed method includes establishing a practice profile having at least one of an administrative parameter, a patient requirement parameter, and a surgeon identifier. The method further includes establishing at least one patient profile corresponding to a patient, wherein the patient profile includes at least one of a patient identifier, a patient requirement parameter, a patient requirement parameter due date, and a surgery identifier. A patient requirement completion date is received and stores, and is compared to the patient requirement parameter due date. A pathway to surgery document that includes the patient requirement parameter due date and the patient requirement completion date is automatically generated and electronically delivered to the patient.

### CROSS-REFERENCE TO RELATED APPLICATION

This application claims the benefit of and priority to U.S. Provisional Application Ser. No. 61/281,963 entitled “BARIATRIC TREATMENT MANAGEMENT SYSTEM AND METHOD”, filed Nov. 24, 2009, the entirety of which is incorporated by reference herein for all purposes.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office file or records, but otherwise reserves all copyright rights whatsoever.

### BACKGROUND

1. Technical Field

The present disclosure relates generally to a medical practice information technology system, and more particularly, to a computerized patient care management system tailored to a bariatric medical practice.

2. Background of Related Art

Bariatrics is a field of medicine that deals with the causes, prevention, and treatment of obesity. Obesity in an individual may be defined as a person having a Body Mass Index (BMI) exceeding a healthy range. Persons suffering from obesity may be at increased risk for health problems, such as heart disease, hypertension, diabetes, many types of cancer, asthma, obstructive sleep apnea, chronic musculoskeletal problems, decreased life expectancy, and so forth.

Bariatric practice may encompass a multi-disciplinary approach to treat obesity, including without limitation dietary counseling, exercise, behavioral and psychological therapy, anti-obesity drugs, medical therapy, and bariatric surgery. A bariatric practitioner may establish a desired treatment plan that is tailored to an individual patient, and may use several approaches in combination.

A patient may be assigned one or more patient requirements, e.g., prerequisites or criteria which must be fulfilled as treatment progresses. For example, a patient's BMI may need to be within a predetermined range before the patient is eligible to undergo bariatric surgery. Moreover, the patient must understand and fully appreciate the lifestyle changes he or she will need to make, both before and after surgery. A patient may need to be seen by one or more specialists, such as a cardiologist, orthopedist, or psychotherapist, before starting a bariatric weight loss regimen. In yet another example, pre-surgical tests and third party payor (e.g., health insurance) requirements must be completed before a patient may undergo bariatric surgery. A patient's compliance with the established bariatric treatment plan is therefore an important factor in achieving the patient's weight loss goals. Tracking and interacting with each patient may be necessary to ensure adherence to the prescribed treatment plan and, in the event a patient deviates from a treatment plan, the practice (e.g., physician and/or staff) may need to take appropriate steps to keep a patient on track.

There are a number of surgical options available to treat obesity. These procedures can be grouped in three main categories: predominantly malabsorptive procedures, predominantly restrictive procedures, and mixed procedure which use both malabsorptive and restrictive techniques. Malabsorptive procedures are those which decreases the digestive system's ability to absorb nutrients, such as biliopancreatic diversion (e.g., the Scopinaro procedure) and the Jejuno-ileal bypass. Restrictive procedures are those which primarily reduces stomach size, such as vertical banded gastroplasty (e.g., Mason procedure or stomach stapling), laparoscopic adjustable gastric band (LAGB), sleeve gastrectomy, and transoral gastroplasty. Mixed procedures which apply both techniques simultaneously includes gastric bypass surgery (e.g., variants of Roux-en-Y gastric anastomosis), loop gastric bypass, sleeve gastrectomy with duodenal switch, and the implantable gastric stimulation. Surgeons within a practice group may specialize in specific procedures.

Medical practices may employ seminars as an informational tool, to educate current patients with respect to their treatment plans, and as a marketing tool to inform potential new patients about bariatric treatment options. Organizing, scheduling, and presenting such seminars, and following up with attendees, may create an administrative burden on a medical practice.

### SUMMARY

Disclosed is a computerized system and method for managing at least one medical practice, which may be a bariatric medical practice, that includes at least one processor configured to execute a set of instructions for performing the component modules of the disclosed method, at least one memory device adapted to store the component modules and data associated therewith, and a user interface to enable interaction between the system and the staff, physicians, and patients of at least one medical practice. The disclosed system and method may include a practice module, a patient module, a patient tracking module, a reporting module, a seminar module, and an executive module. The at least one processor may be include within a computer, which may be configured as a networked web or application server, or a cluster or combination of computers. The computer may provide a local user interface, e.g., a stand-alone application, and/or may provide a remote user interface via a data communication link such as without limitation a local area network (LAN) or the Internet using, e.g., a web browser. In an embodiment, the disclosed system and method may include the capability to support a plurality of medical practices.

It is envisioned that the disclosed system and method be implemented as a hosted service wherein a central server or pool of servers provides the medical practice management modules described herein for any number of independent or affiliated medical practices. It is also envisioned the disclosed system and method be implemented as a virtual machine, running under, for example without limitation, virtualization hypervisors provided by VMware, Inc., of Palo Alto, Calif., USA. It is further envisioned the disclosed system be implemented within a cloud computing architecture wherein hardware computing resources are allocatable in a scalable fashion, such that the disclosed system and method may be executed on an arbitrary number and type of hardware computing devices.

The practice profile module enables the creation and management of a practice profile. The practice profile includes, without limitation, information related to business aspects of the practice, including without limitation primary practice information, e.g., practice name, address, telephone and fax numbers, Internet addresses including email and website URL, and the like; user administration, e.g., physician and staff user accounts and account privileges; surgeon administration, e.g., data relating to surgeons, affiliations, and specialties thereof; seminar management, e.g., establishing and scheduling patient-focused seminars; managing default and automatic patient requirements, e.g., required pre-surgical tests, specialist office visits, and health goals (e.g., smoking cessation); managing a professional network affiliated with the practice, e.g., referral and referring physicians and specialists; managing insurance carrier information relating to health insurance and plans accepted by the practice; and managing patient intake and follow-up questionnaire templates.

The patient profile module facilitates management of patient profiles relating to existing and/or prospective patients of the practice. The patient profile includes, without limitation, patient identification and contact information, preferred mode of communication (e.g., postal mail, telephone, email, SMS message, and other modes of communication now or in the future known), medical information, referring entity, employer information, health insurance information, patient requirements and schedule thereof, and physician/surgeon assignments. The patient profile module may initiate a communication to the patient upon a predetermined event, e.g., the creation, change, or removal of patient information. Such communication may include an email or SMS message, an automated telephone message, and/or human telephonic contact. Additionally or alternatively, the patient profile module may generate a patient requirements document which may detail the steps the patient must take before undergoing surgery.

The seminar module is configured to facilitate the organizing, scheduling, and presentation of patient seminars. The seminar module enables the registration of existing and prospective patients for a seminar. Upon registering an existing patient for a seminar, previously-entered patient data may automatically be transferred into the seminar registration for the existing patient. Alternatively, if a new or prospective patient is registered for a seminar, patient seminar data entered into the system (which may include patient profile data) may be retained for future use by the patient profile module, and other modules as needed. The seminar module also provides the capability to cancel a seminar registration and to facilitate the entry of associated information, such as without limitation, a reason for the cancelation. The seminar module also includes the capability to provide an attendance roster to facilitate registration of walk-in attendees as well as pre-registered attendees. Additionally, the attendance roster may include the ability to record which registrants did, in fact, attend the seminar, as well as those that did not. In the event a registrant cancels or fails to attend the seminar, the seminar module includes the ability to schedule a future contact or communication with the registrant.

The patient tracking module includes a patient-facing user interface to enable a patient to interact with the system. A patient may access requirements status, receive and send message to/from the practice, generate a requirement status report, upload and view digital images (“before and after” photographs), and/or update personal information.

The reporting module is configured to provide at least one predefined or ad-hoc report related to the activities, patients, and operations of the practice. For example without limitation, such reports may include an “At-A-Glance” report which illustrates such items as surgeries performed, informed consents received, insurance authorizations granted, insurance authorizations submitted, requirements scheduled, seminar registration, seminar attendance, patient status, and so forth. The reporting module may also provide action item reports, e.g., surgeries to be scheduled, patient telephone calls to be made, missed requirements, outstanding authorizations, surgeon consults to schedule, and so forth. A report may be presented alone, or within an aggregation display (e.g., a window within a home page or summary screen).

The disclosed system and method may include an executive module which presents a consolidated view of the system to staff and/or physicians. The executive module may present an aggregation of reports in a single page view to enable a user to quickly comprehend the current state of the practice. The executive module may additionally or alternative initiate communication with the patient, physicians, surgeons, professional affiliates, insurance carriers, and so forth.

Also disclosed is a computer-implemented method for managing a medical practice. The disclosed method includes establishing a practice profile having at least one of an administrative parameter, a patient requirement parameter, and a surgeon identifier. The method further includes establishing at least one patient profile corresponding to a patient, wherein the patient profile includes at least one of a patient identifier, a patient requirement parameter, a patient requirement parameter due date, and a surgery identifier. A patient requirement completion date is received and stores, and is compared to the patient requirement parameter due date. A pathway to surgery document that includes the patient requirement parameter due date and the patient requirement completion date is automatically generated and electronically delivered to the patient.

In another aspect, a computer-implemented medical practice management system is disclosed. The disclosed medical practice management system includes at least one processor operatively coupled to a storage device, and a data interface operatively coupled to the processor and adapted to receive a user input from an access device. A practice module is operatively coupled to the processor and is configured to receive, store, and display information relating to a practice profile, wherein the practice profile includes at least one preset patient requirement. The system also includes a patient module operatively coupled to the processor that is configured to receive, store, and display information relating to a patient profile, wherein the patient profile includes at least one patient requirement and a corresponding patient requirement due date. The system further includes a tracking module operatively coupled to the processor that is configured to compare the patient requirement due date to at least one of a patient requirement completion date or a current date, and to generate a pathway to surgery document based upon the patient requirement due date, the patient requirement completion date, and/or a current date.

Also disclosed is computer-readable media comprising a set of executable instructions for performing a method for managing a medical practice as described herein.

### BRIEF DESCRIPTION OF THE DRAWINGS

Various embodiments of the disclosed system and method are described herein with reference to the drawings wherein:

FIG. 1 is a block diagram of an embodiment of a patient treatment management system in accordance with the present invention;

FIG. 2 is a flow diagram of an embodiment of a practice management module in accordance with the present disclosure;

FIG. 3 is a schematic diagram of an embodiment of a practice profile page in accordance with present disclosure;

FIG. 4 is a schematic diagram of an embodiment of a manage users page in accordance with present disclosure;

FIG. 5 is a schematic diagram of an embodiment of a manage surgeon page in accordance with present disclosure;

FIG. 6 is a schematic diagram of an embodiment of a first view of a manage seminars page in accordance with present disclosure;

FIG. 7 is a schematic diagram of an embodiment of a second view of a manage seminars page in accordance with present disclosure;

FIG. 8 is a schematic diagram of an embodiment of a third view of a manage seminars page in accordance with present disclosure;

FIG. 9 is a schematic diagram of an embodiment of a manage professional network page in accordance with present disclosure;

FIG. 10 is a schematic diagram of an embodiment of an add specialist page in accordance with present disclosure;

FIG. 11 is a schematic diagram of an embodiment of an edit insurance carrier page in accordance with present disclosure;

FIG. 11A is a schematic diagram of an embodiment of a health questionnaire preset page in accordance with present disclosure;

FIG. 12 is a schematic diagram of an embodiment of pre-surgery requirements preset page in accordance with present disclosure;

FIG. 13 is a schematic diagram of an embodiment of an automatic requirement reset page in accordance with present disclosure;

FIG. 14 is a flow diagram of an embodiment of a patient management module in accordance with the present disclosure;

FIG. 15 is a schematic diagram of an embodiment of a patient profile page in accordance with present disclosure;

FIG. 16A is a schematic diagram of an embodiment of a first benefits verification page in accordance with present disclosure;

FIG. 16B is a schematic diagram of an embodiment of a second benefits verification page in accordance with present disclosure;

FIG. 17 is a schematic diagram of an embodiment of a benefits verification denial page in accordance with present disclosure;

FIG. 17A is a schematic diagram of an embodiment of a patient deactivation page in accordance with present disclosure;

FIG. 18 is a schematic diagram of an embodiment of an inward-facing seminar registration page in accordance with present disclosure;

FIG. 19 is a schematic diagram of an embodiment of an outward-facing seminar registration page in accordance with present disclosure;

FIG. 20 is a schematic diagram of an embodiment of a seminar cancelation page in accordance with present disclosure;

FIG. 21 is a schematic diagram of an embodiment of a patient selection page in accordance with present disclosure;

FIG. 22 is a schematic diagram of an embodiment of a patient tracking page in accordance with present disclosure;

FIG. 23 is a schematic diagram of an embodiment of a patient progress update page in accordance with present disclosure;

FIG. 24 is a schematic diagram of an embodiment of a communications log page in accordance with present disclosure; and

FIG. 25 is a schematic diagram of an embodiment of a home page in accordance with present disclosure.

### DETAILED DESCRIPTION

Particular embodiments of the present disclosure are described hereinbelow with reference to the accompanying drawings; however, it is to be understood that the disclosed embodiments are merely exemplary of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In the discussion contained herein, the terms user interface element and/or button are understood to be non-limiting, and include other user interface elements such as, without limitation, a hyperlink, clickable image, and the like.

Additionally, the present invention may be described herein in terms of functional block components, code listings, optional selections, page displays, and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created can be executed by any computer having an Internet Web Browser, on a variety of operating systems including Windows, Macintosh, and/or Linux.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Examples are presented herein which may include sample data items (e.g., names, dates, etc.) which are intended as exemplary and are not to be construed as limiting. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

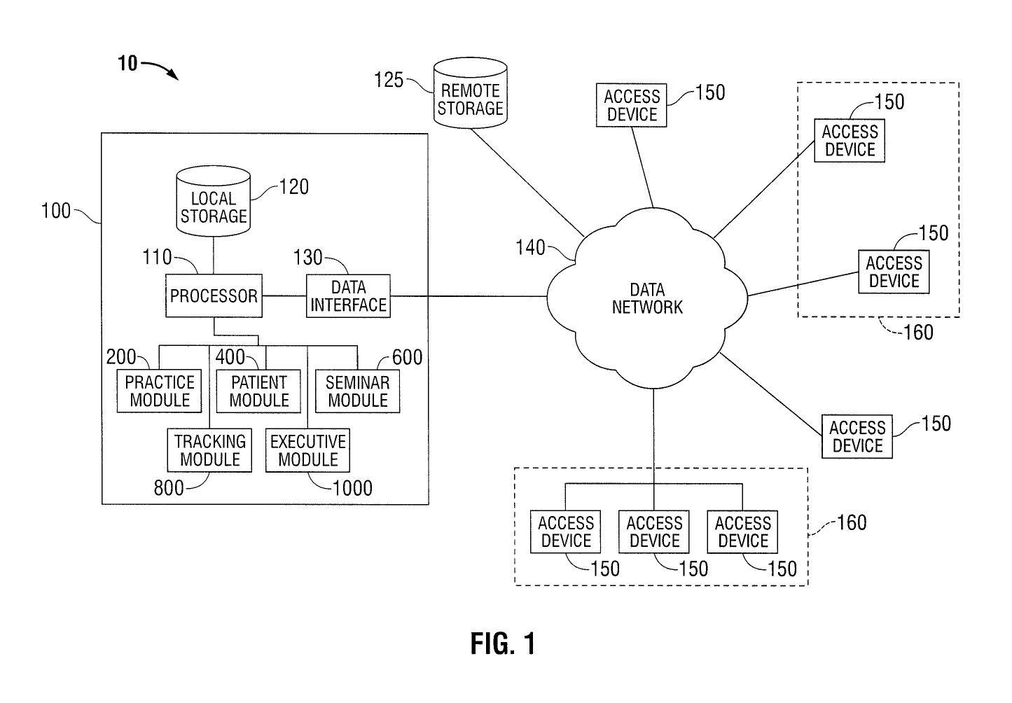

FIG. 1 illustrates a bariatric patient treatment management system 10 in accordance with the present invention. The system 10 includes a bariatric patient treatment management computer 100 having at least one processor 110 that is operably coupled to a local storage device 120, a data interface 130, and at least one of a practice module 200, a patient module 400, a seminar module 600, a tracking module 800, and/or an executive module 1000. Local storage device 120 may include one or more hard drives, semiconductor memory devices e.g., RAM memory, flash memory, solid state disks (SSDs), and so forth. Additionally or alternatively, a remote storage device 125, e.g., a network attached storage device (NAS) and/or a storage area network (SAN) may be operably coupled to computer 100 via data network 140. Data interface 130 may include one or more network interface cards such as, without limitation, ethernet (10 MBit/sec), fast ethernet (100 MBit/sec), gigabit ethernet (1,000 MBit/sec), optical fiber, and/or token ring network cards. Data interface 130 may be operably coupled to at least one data network 140, such as a local area network (LAN), a wide area network (WAN), a wireless network (IEEE 802.11 “WiFi” and/or cellular networks) and/or a public data network such as the interne. Computer 100 may be operably coupled, via data network 140, to at least one access device 150, which may include without limitation, a personal computer (e.g., desktop or notebook computer), a handheld computing device, a wireless computing device (e.g., “smart phone”), an interactive television set-top box, and/or a self-service kiosk. In use, computer 100 causes to be displayed on access device 150 one or more user interface elements (e.g., screens, web pages) which facilitate interaction between a user and computer 100.

It is also contemplated that computer 100 and/or components thereof may be embodied as a virtual machine, e.g., a software replication of a physical machine, wherein the virtual machine is abstracted from the underlying physical hardware upon which the virtual machine runs. It is further contemplated that computer 100 and/or components thereof may be embodied in a virtual cloud, e.g., the disclosed system and method may be executed within a shared pool of computing resources, e.g., a shared pool of hardware computing devices.

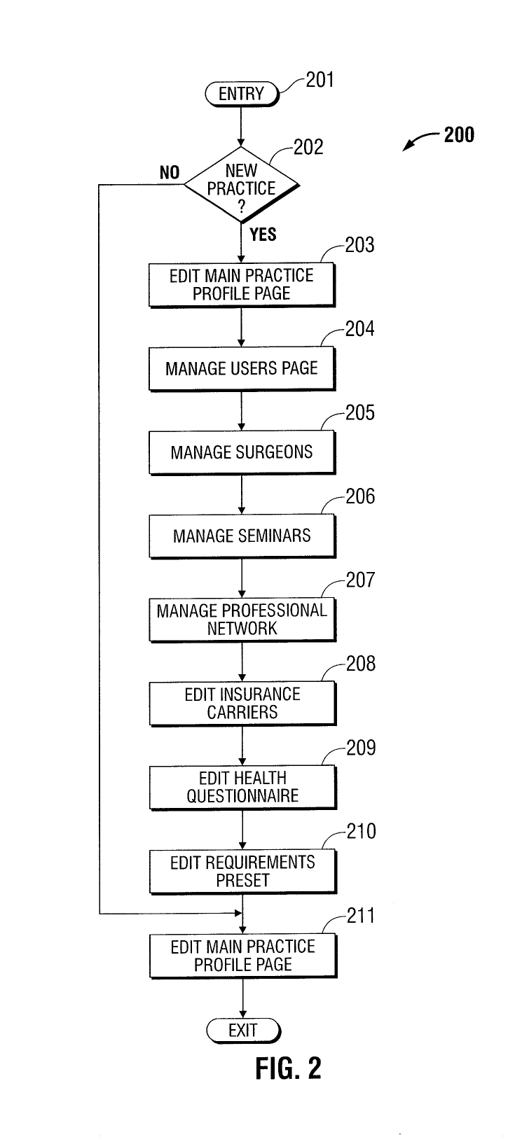

With reference to FIG. 2, practice module 200 is configured to facilitate the entry, by a user, of data relating to and/or characterizing a medical practice. After completion of the initial entry of practice data, practice module 200 may be utilized by a user to perform ongoing maintenance (e.g., add, change, inquire, and delete) of practice data. A determination of whether entry of initial practice data is necessary, or whether maintenance of existing practice data is possible, is performed in the step 202. Such a determination may be based, at least in part, on one or more indicators, e.g., whether one or more practice profile data elements is unpopulated (e.g., null, blank, zero, or unused), whether a “new profile” flag is set, and/or how practice module 200 was invoked.

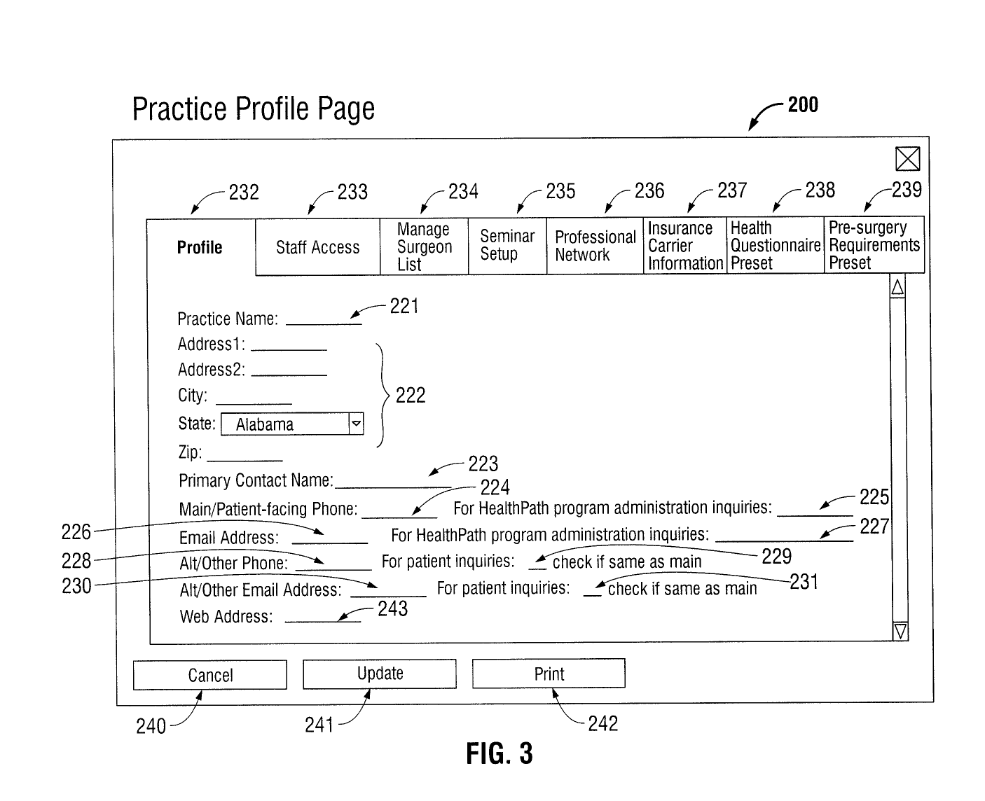

Referring to FIG. 3, if in the step 202 a determination is made that a new practice profile needs to be established, the step 203 through 210 are performed wherein each screen of the practice profile module 200 is presented in succession to the user for initial data entry, i.e., the practice profile page 220, a staff access page 244, a manage surgeon page 253, a seminar page 263, a professional network page 316, an insurance carrier page 342, a health questionnaire page 365, and a requirements page 352 The main practice profile page 220 is configured to facilitate the entry, modification, and deletion of at least one data fields relating to the practice profile. Such data fields include, but are not limited to, a practice name 221, street address 222, a primary contact name 223, a main (e.g., “patient-facing”) telephone number 224, a main email address 226, and a program administrator inquiry telephone number 225 and email address 227. Additionally, an alternative telephone number 228 and alternative email address 230 may be provided, either or both having a respective indicator 229, 231 (e.g., Boolean or true/false flag) that indicates whether the alternative telephone number 228 and/or alternative email address 230 is the same as main telephone number 225 and/or main email address 226. A web address 243 (e.g., uniform resource locator, or URL) may be specified.

In use, a user populates the data fields using any suitable manner of data entry (e.g., physical or on-screen keyboard, touchscreen, stylus, mouse, trackpad, and so forth). After performing the desired data entry, a user may confirm acceptance of the entered data by actuating an update user interface element 241. Alternatively, a user may cancel the entered data by actuating a cancel user interface element 240. Additionally or alternatively, a user may cause a report of the practice profile data fields to be generated by actuating a print user interface element 242. Update user interface element 241, cancel user interface element 240, and/or print user interface element 242 may be any suitable form of user interface element, including without limitation a clickable pushbutton, drop down menu, keystroke or keystroke combination, and so forth, as will be appreciated.

Practice profile page 220, as well as other pages described herein, includes one or more navigation tabs 232 et seq. which may indicate the currently-displayed page or enable a user to access other pages. As can be seen in FIG. 3, practice profile page 220 includes a profile tab 232, a staff access tab 233, a manage surgeon tab 234, a seminar tab 235, a professional network tab 236, an insurance carrier flag 237, a heath questionnaire tab 238, and a requirements tab 239.

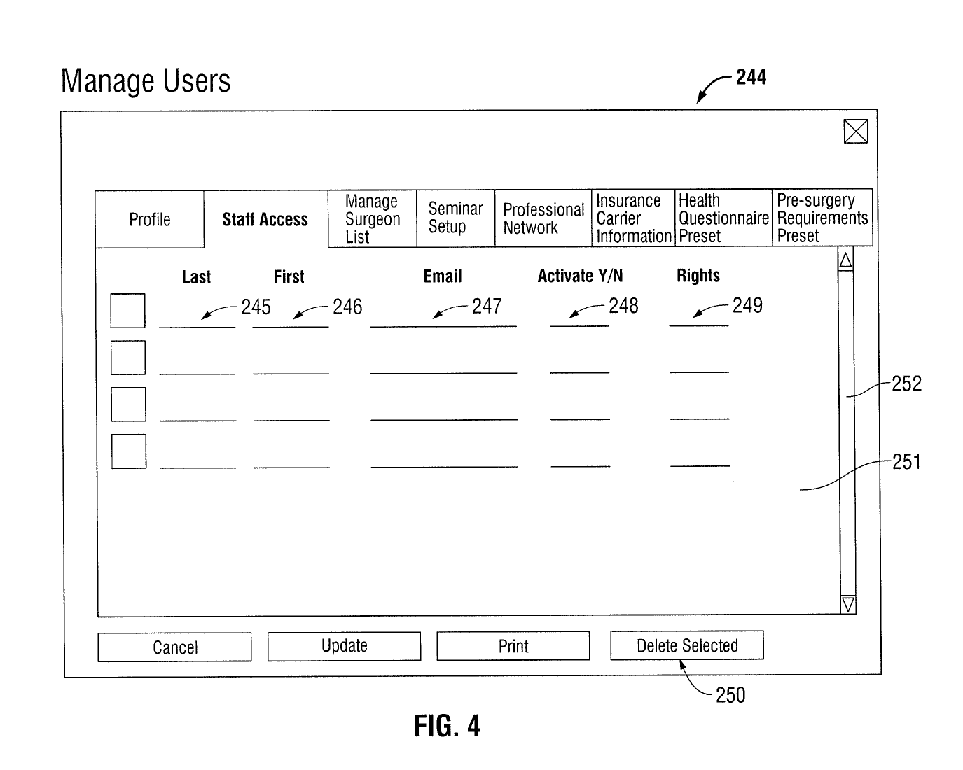

As seen in FIG. 4, a manage users page 244 is configured to enable the addition, maintenance, and deletion of users that are authorized to access the system 10. Manage user page 244 includes at least one set of data fields 245-249, each such set of data fields relating to an individual authorized user. In particular, provided are a user last name field 245, a user first name field 246, a user email address field 247, an activate fields 248, and a rights field 249. Data fields 245-249 may be arranged in a single row, as shown, or may be presented in any suitable format. A plurality of rows may be provided to accommodate a plurality of users. Additionally or alternatively, the rows may be presented in a scrolling region 251 to enable viewing and/or modification of an indefinite number of user data fields using, in part, scroll bar 252. Manage users page 244 may additionally include a delete user interface element 250 that is configured to cause deletion of a designated set of data fields relating to an individual user.

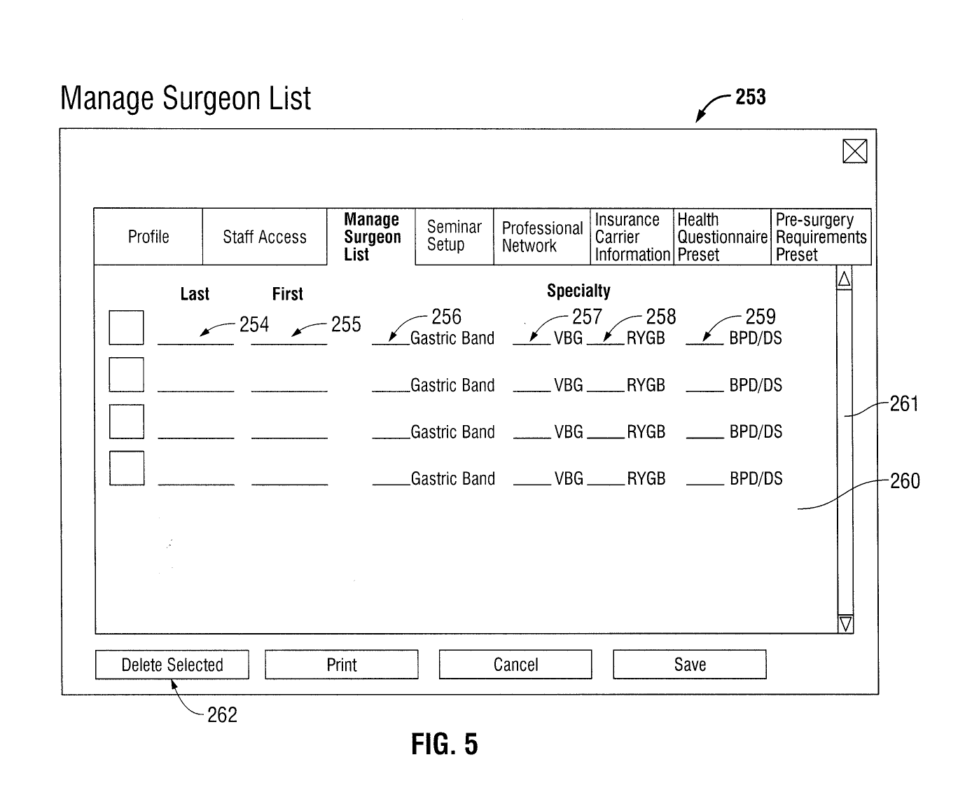

Turning to FIG. 5, a manage surgeon page 253 is configured to enable the addition, maintenance, and deletion of surgeons of the practice. Manage surgeon page 253 includes at least one set of data fields 254-259, each such set of data fields relating to an individual surgeon. In particular, provided are a surgeon last name field 254, a surgeon first name field 255, and Boolean specialty fields 256-259 that indicate bariatric surgical procedure(s) in which the surgeon specializes. Specialty fields include gastric band data field 256, a VBG data field 257, an RYGB data field 258, and a BPD/DS data field 259. Data fields 254-259 may be arranged in a single row, as shown, or may be presented in any suitable format. A plurality of rows may be provided to accommodate a plurality of surgeons. Additionally or alternatively, the rows may be presented in a scrolling region 260 to enable viewing and/or modification of an indefinite number of surgeon data fields using, in part, scroll bar 261. Manage users page 253 may additionally include a delete surgeon interface element 262 that is configured to cause deletion of a designated set of data fields relating to a surgeon.

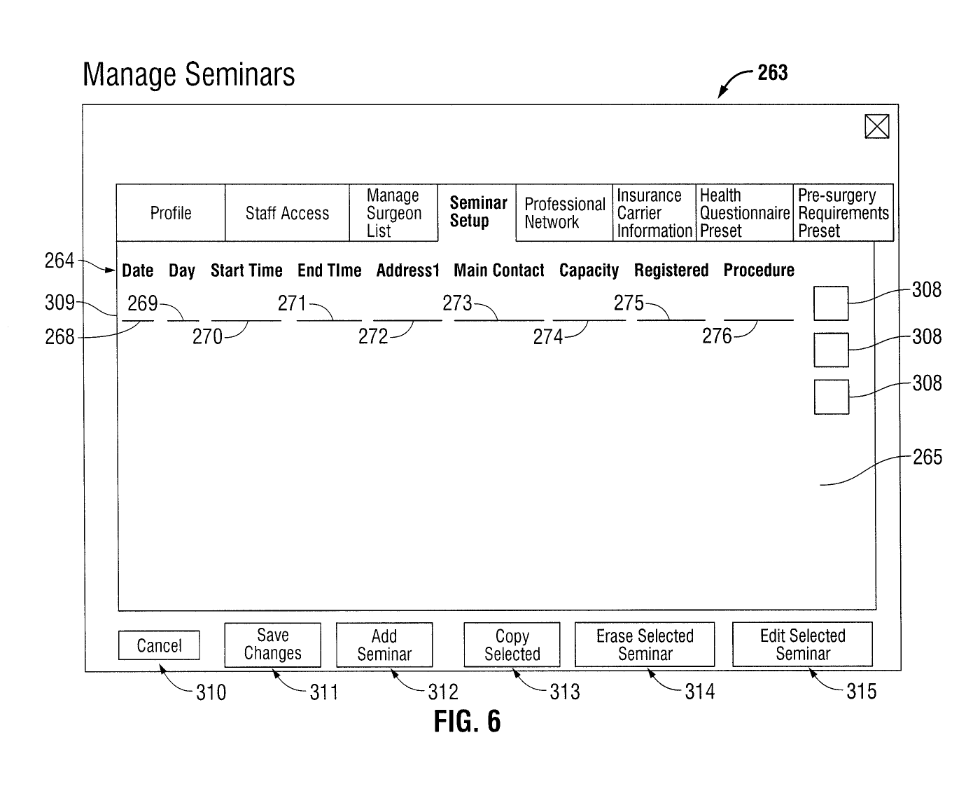

FIGS. 6, 7, and 8 illustrate a manage seminars page 263. The manage seminars page 263 includes a display region 264 in which various aspects (e.g., views) of seminar data may be displayed and/or edited. As seen in FIG. 6, a seminar list view 265 is presented in display region 264 wherein a list of seminars is displayed in one or more seminar rows 309 in a general overview format. Data fields which may be displayed in seminar list view 265 include seminar date 268, seminar day-of-week 269, start time 271 and end time 271, seminar location address 272, a seminar main contact 273, seminar capacity (e.g., maximum number of attendees) 274, number of registered attendees 275, and a seminar procedure 276, e.g., the surgical procedure(s) to be discussed at the seminar. A selection check box 308 may be associated with each seminar row 309. In use, a user may actuate an add seminar user interface element 312, which may be a clickable button, which facilitates entry of a new seminar into the system. Additionally or alternatively, a user may create a new seminar based upon information stored with respect to an existing seminar (e.g., source seminar) by activating a selection check box associated with a desired source seminar line 309, and activating a copy selected button 313. One or more seminars may be deleted by activating a selection check box 308 associated with a desired seminar line 309 representing the seminar(s) to be deleted, and activating an erase selected seminar button 315. A seminar may be selected for editing by activating a selection check box 308 associated with a desired source seminar line 309, and activating an edit selected button 315. Any additions and/or changes that have been entered by the use may be committed by activation of the save changes button 311. Alternatively, such additions and/or changes may be discarded (e.g., not committed) by activation of the cancel button 310.

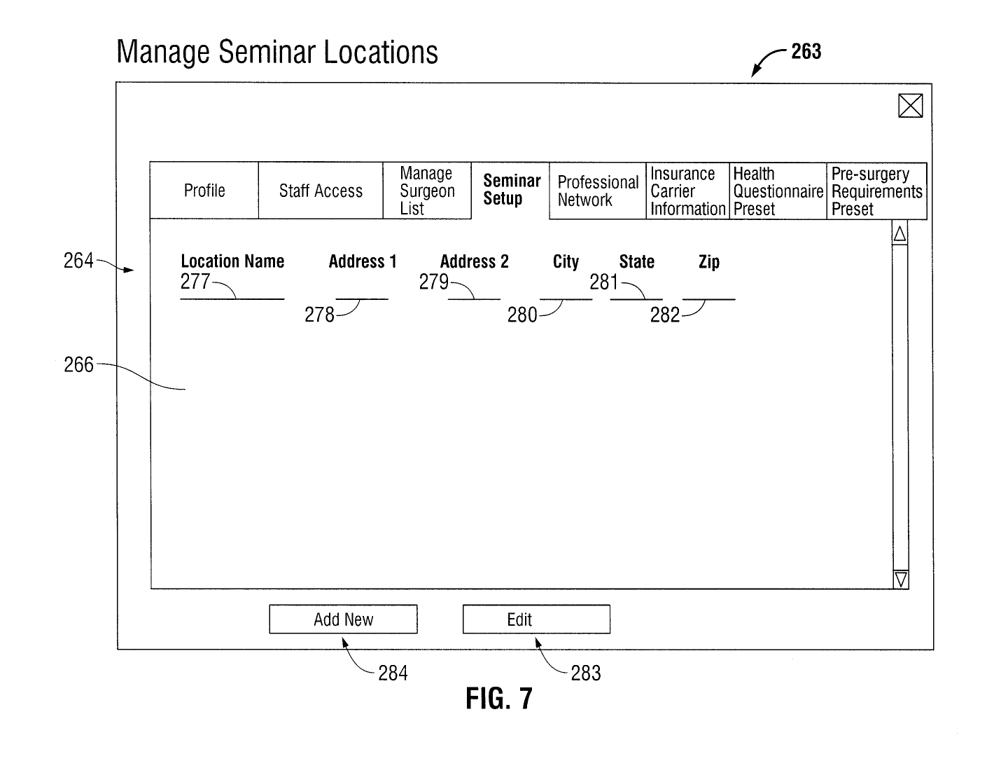

In some instances, a practice will conduct seminars at one or more recurring locations. In FIG. 7, a seminar location view 266 is shown wherein a user may input and/or edit seminar location data corresponding to the location(s) at which seminars are conducted. Data fields which may be viewed and/or edited in seminar list view 266 include seminar location name 277, a first seminar street address 278, a second seminar street address 279, and a seminar city 280, state 281, and postal code 282. An existing seminar location may be edited by actuating an edit user interface element 283, which may be a button, hyperlink, or other suitable user interface control. A new seminar may be added by activating an add new button 284, which is configured to cause a new set of blank seminar fields 277-282 to be presented for population by a user. A seminar location code (not explicitly shown) may be provided to facilitate identification of an individual seminar location.

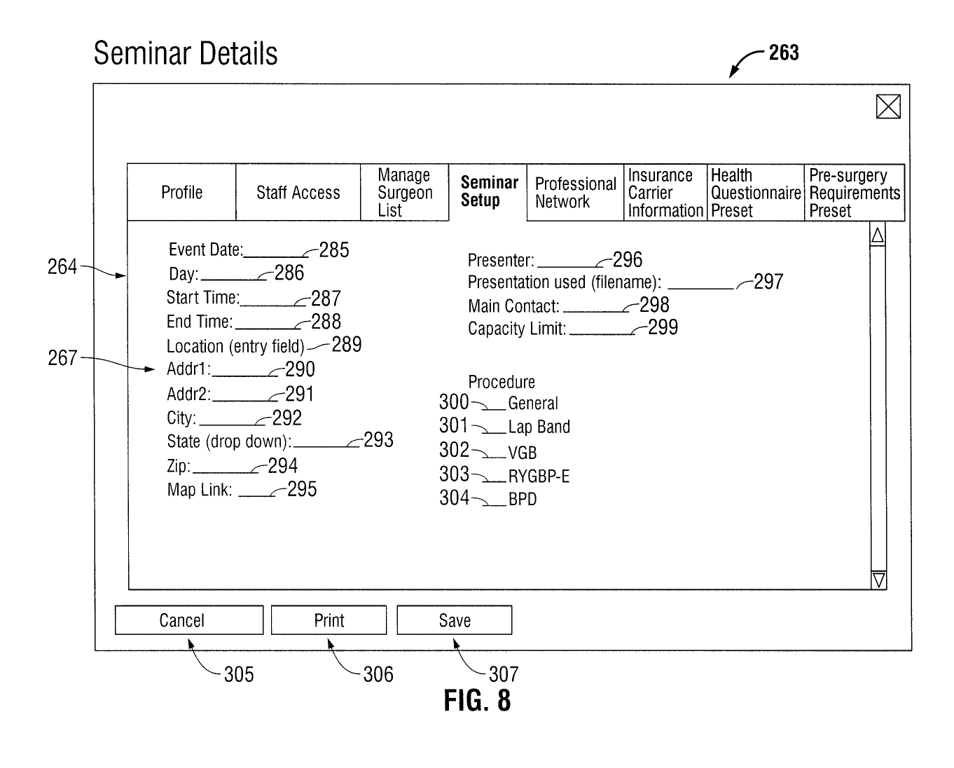

As best seen with reference to FIG. 8, a seminar detail view 267 facilitates the input and/or editing of a comprehensive set of seminar-related data. Data fields which may be viewed and/or edited in seminar detail view 267 include seminar date 285, seminar start time 287 and end time 288, seminar location 289 (which may be a seminar location code), a first and second seminar street address 289 and 290, respectively, a seminar city 291, state 292, and postal code 293, name of seminar presenter 296, presentation document filename 297 (e.g., a PowerPoint® file to be used during the seminar), seminar main contact 298 (which may be a name, telephone number, email address, and the like), seminar capacity limit 299 (e.g., maximum number of attendees), and a selection of which surgical procedure is to be discussed at the seminar, such as without limitation, a Lap Band selection 301, a VGB (Vertical Banded Gastroplasty) selection 302, a RYGBP-E (Extended Roux-en-Y Gastric Bypass) selection 303, and a BPD (Biliopancreatic Diversion) selection 304. Additionally, a “general” selection 300 may be provided where a seminar is not directed to a specific type of surgery (e.g., a general introductory seminar). After performing the desired data entry, a user may confirm acceptance of the entered data by actuating a save user interface element 307. Alternatively, a user may cancel the entered data by actuating a cancel user interface element 305. Additionally or alternatively, a user may cause a report of the seminar data fields to be generated by actuating a print user interface element 306. Save user interface element 307, cancel user interface element 305, and/or print user interface element 306 may be any suitable form of user interface element, including without limitation a clickable pushbutton, drop down menu, keystroke or keystroke combination, and so forth as will be appreciated.

In embodiments, certain data fields may be populated based in whole or in part on other data fields. By way of example, and without limitation, seminar day field 286 may be automatically populated with the day of week corresponding to the seminar date 285. In another non-limiting example, map link field 295 may be automatically populated with a URL (uniform resource locator) of a web page which includes a map of and/or directions to the seminar location. Such map may itself be automatically generated based upon a street address, latitude and longitude, or other geographic indicia, such as those generated by on-line mapping services e.g., Google® Maps, Mapquest®, and the like.

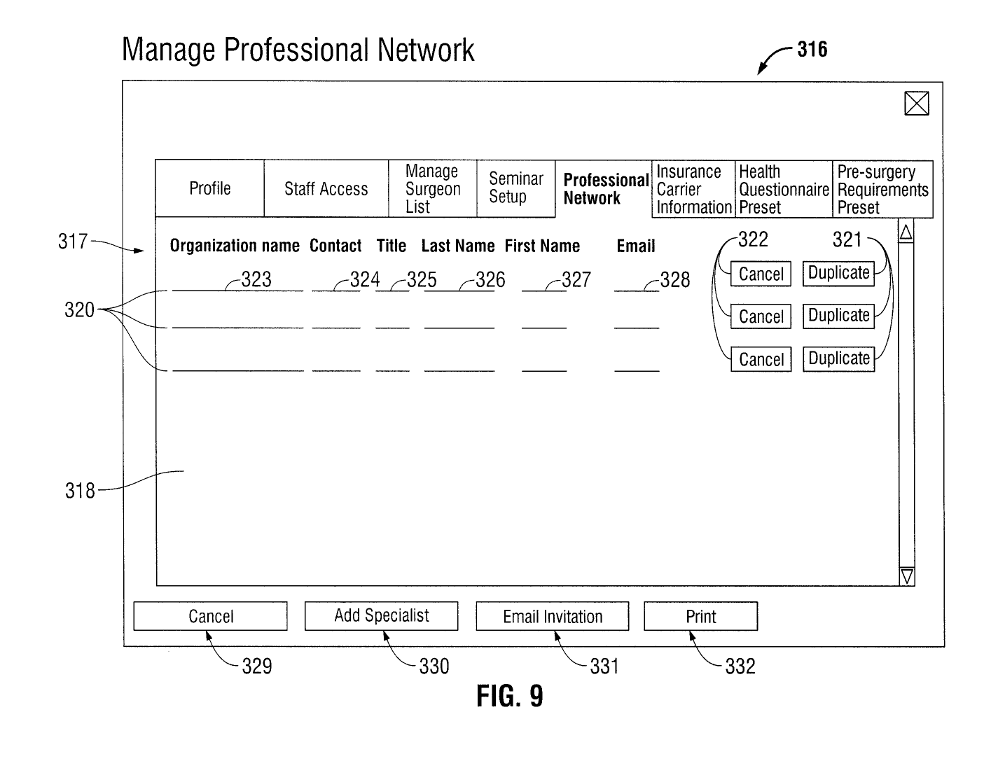

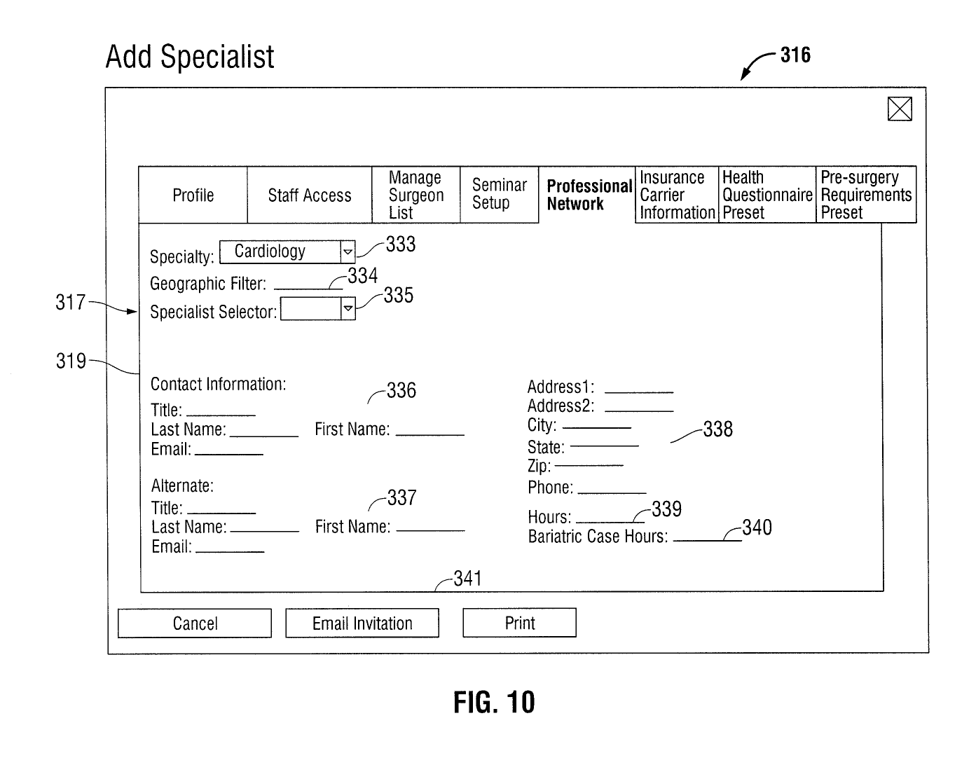

With reference to FIGS. 9 and 10, a “manage professional network” page 316 is configured to enable the addition, maintenance, and deletion of referral (and referring) practices and specialists with whom the practice maintains a professional relationship. The manage professional network page 316 includes a display region 317 in which various aspects (e.g., views) of professional network data may be displayed and/or edited. As seen in FIG. 9, a professional network list view 318 is presented in display region 317 wherein a list of affiliated practices is displayed in one or more rows 320 in a general overview format. Data fields which may be displayed in professional network list view 318 include an organization name 323, contact information 324 (e.g., contact person, telephone number, etc.), title 325, last name 326, first name 327, and an email address 328. A duplicate button 321 and a cancel button 322 may be associated with each row 320. In use, a user may select a desired row for input and/or editing by, e.g., clicking on a data field within the desired row 320. A user may revert inputted and/or edited data by clicking on the cancel button 322 associated with the desired row and or cancel button 329.

Advantageously, an “email invitation” user interface element 331 (e.g., button, link etc.) is provided to cause to be transmitted to the affiliated professional practice an invitation communication, e.g., an invitation email. The invitation email may include a generic, predetermined message which has been merged with inputted data corresponding to the affiliated professional practice to form a personalized invitation message. In an embodiment, the invitation message may be presented to the user in an editor window to enable the user to review and revise the message, if desired.

Affiliated professional practices may have one or more specialists associated therewith. In FIG. 10, an “add specialist” view 319 is displayed in display region 317 whereby information relating to one or more individual specialists in an affiliated professional practice is maintained. The add specialist view includes data items relating to a particular specialist, including without limitation, primary contact information 336, alternate contact information 337, and/or address information 338. Additionally, a specialty identifier 333 may provided to enable the identification of the specialist's area of expertise. Specialty identifier 333 may be entered as a free-form test field, or, preferably, selected from a predetermined list of choices presented by, e.g., a drop-down menu. Similarly, a specialist selector 335 may be provided to enable additional specialist selection criteria to be maintained. A geographic filter 334 may be provided which may associate a specialist with a particular geographic region, e.g., a set of one or more zipcodes, municipalities, and the like. General hours of business 339 (e.g., patient-seeing hours) and bariatric case hours 340 may additionally or alternatively be stored. An “email invitation” button may be provided to dispatch an invitation to the individual specialist, as described hereinabove.

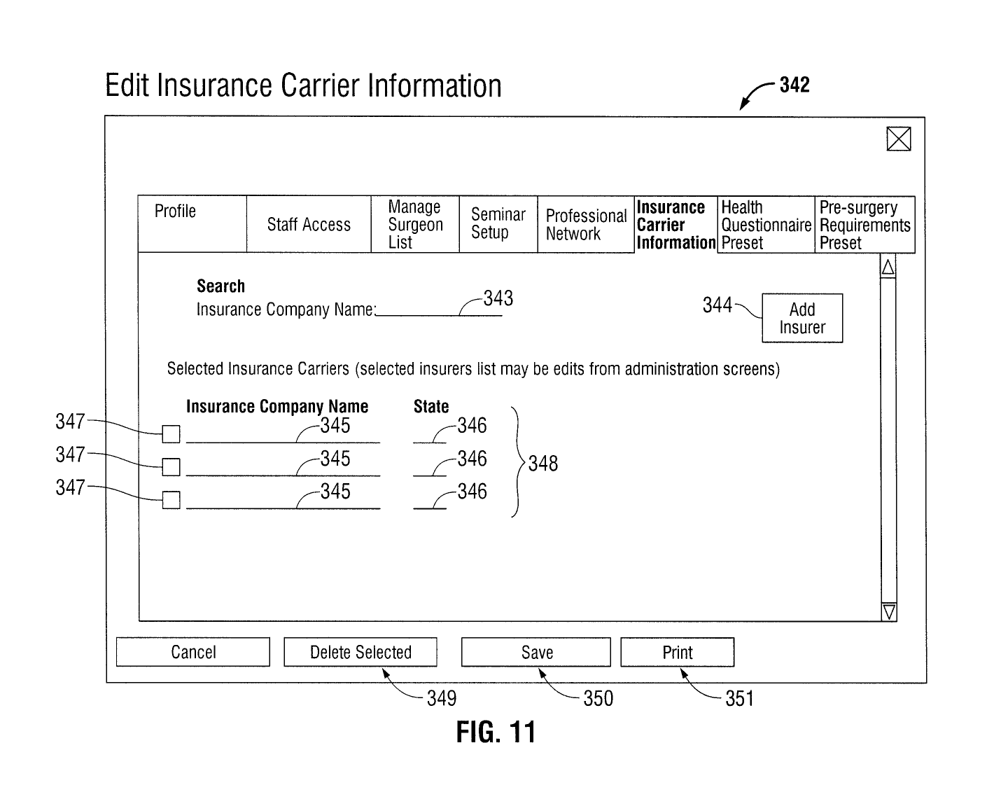

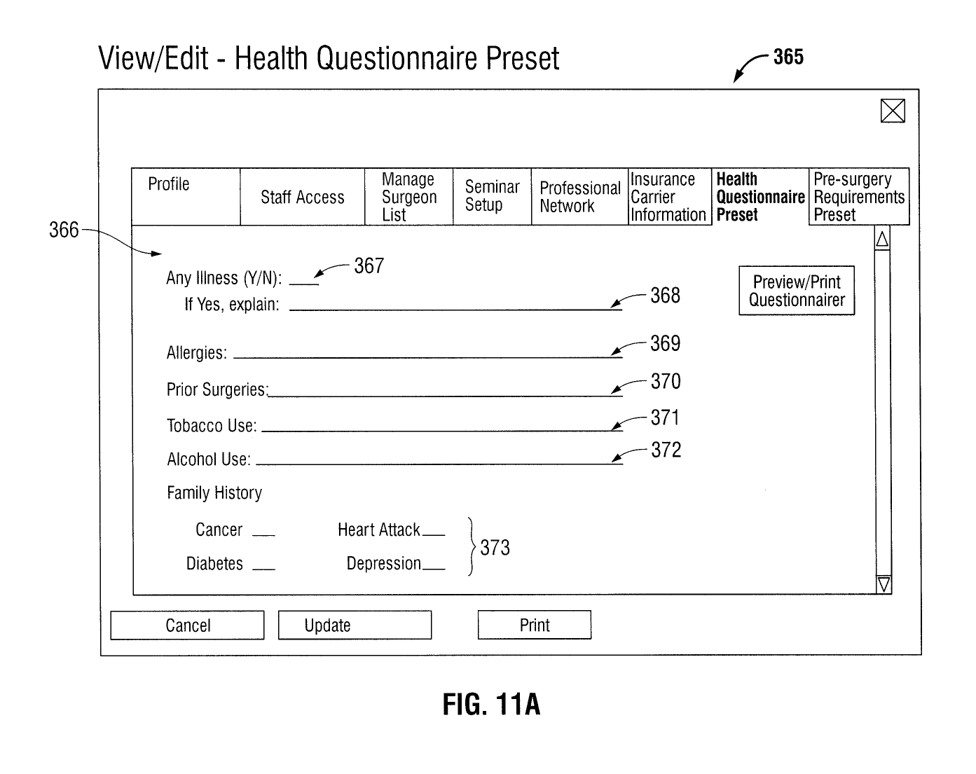

Turning to FIG. 11, an “edit insurance carrier information” page 342 is presented whereby health insurance carriers and/or place which are accepted by the practice may be maintained. A database that includes a predetermined list of insurance carrier names and/or plans specific to each carrier is accessed via insurance company search field 343. Insurance company search field 343 is configured as a predictive search field whereby, as a user inputs text representing an insurance carrier name, a list of possible matches corresponding to the inputted text is presented as, e.g., a drop down list of insurance carriers name choices from which the user may select. In this manner, a user is not required to know the precise name of an insurance carrier business entity, and moreover, the entry of invalid or misspelled insurance carrier information may be avoided.

A user, upon selection of a desired insurance carrier, may add the chosen insurance carrier to a list of approved carriers 348 with which the practice maintains a business relationship by actuating the “add insurer” button 344. The list of approved carriers may include an insurance company name field 354 and state field 346. A selection check box 347 is provided for each line of the approved carrier list 348 to enable a selection of at least one line thereof for deletion by actuation of the delete selected button 349. Selections may be saved by actuating the save button 350, and a report thereof may be printed by actuating the print button 351.

In FIG. 11A, a health questionnaire preset page 365 is shown with which a practice may configure one or more questions 366 relating to a patient's current health and/or health history. During patient intake, a patient may be required to provide the information requested in the questionnaire preset page 365. By way of example only, and without limitations, the health questionnaire preset page 365 may include one or more questionnaire items relating to any illnesses of the patient 367, 368, one or more questionnaire items relating to allergies 369, one or more questionnaire items relating to prior surgeries 370, one or more questionnaire items relating to tobacco use 371 and/or alcohol use 372, and one or more questionnaire items relating to a family medical history 373 of the patient.

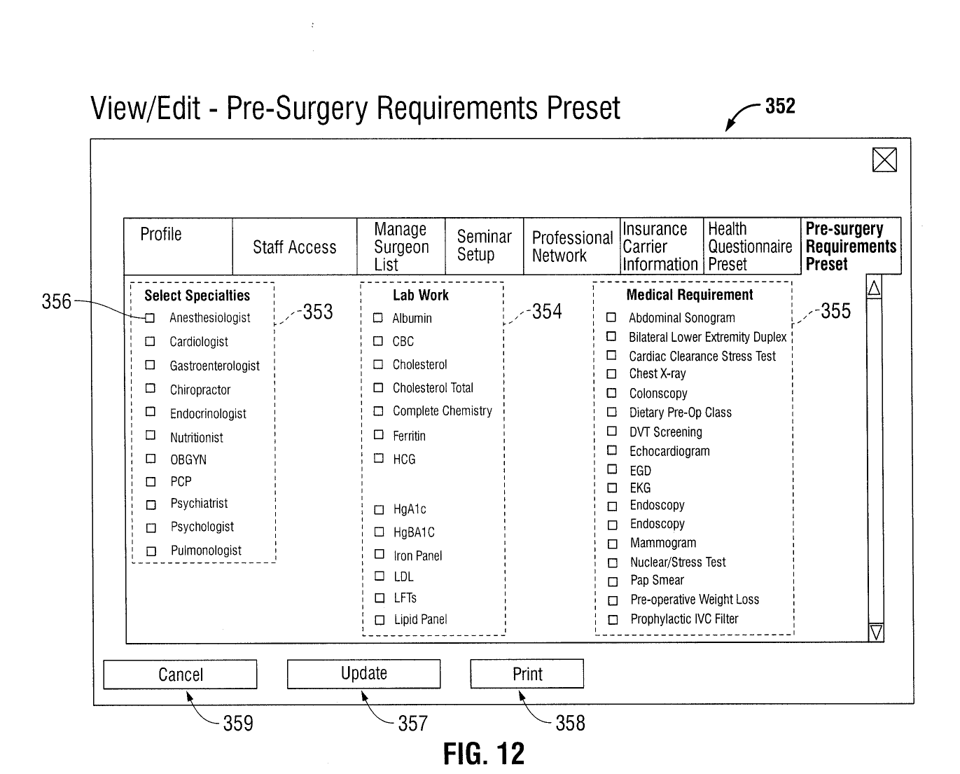

In FIG. 12, a “pre-surgery requirements preset” page 352 is presented wherein the desire pre-surgical requirements template for the practice may be defined. In an embodiment, the pre-surgical requirements are organized into three clinical classifications, selected specialties 353 (which may include, e.g., Anesthesiologist, Cardiologist, etc.), lab work 354 (which may include, e.g., Albumun, CBC, Cholesterol, etc.), and medical requirements 355 (which may include, e.g., Abdominal Sonogram, Bilateral Lower Extremity Duplex, Carical Clearance Stress Test, etc.). A check box 356 is associated with each requirement to enable a user to select (e.g., activate) and/or deselect (e.g., deactivate) pre-surgical requirements as desired. Pre-surgery requirements preset page 352 includes an update button 357 to commit selected changes, a print button 358 to cause a surgical requirements report to be generated, and a cancel button 359, which causes any selections and/or changes thereto to be reverted. The preset pre-surgical requirements may be changed on a per-patient basis, such as, e.g., when a patient profile is entered, as will be discussed in detail hereinbelow.

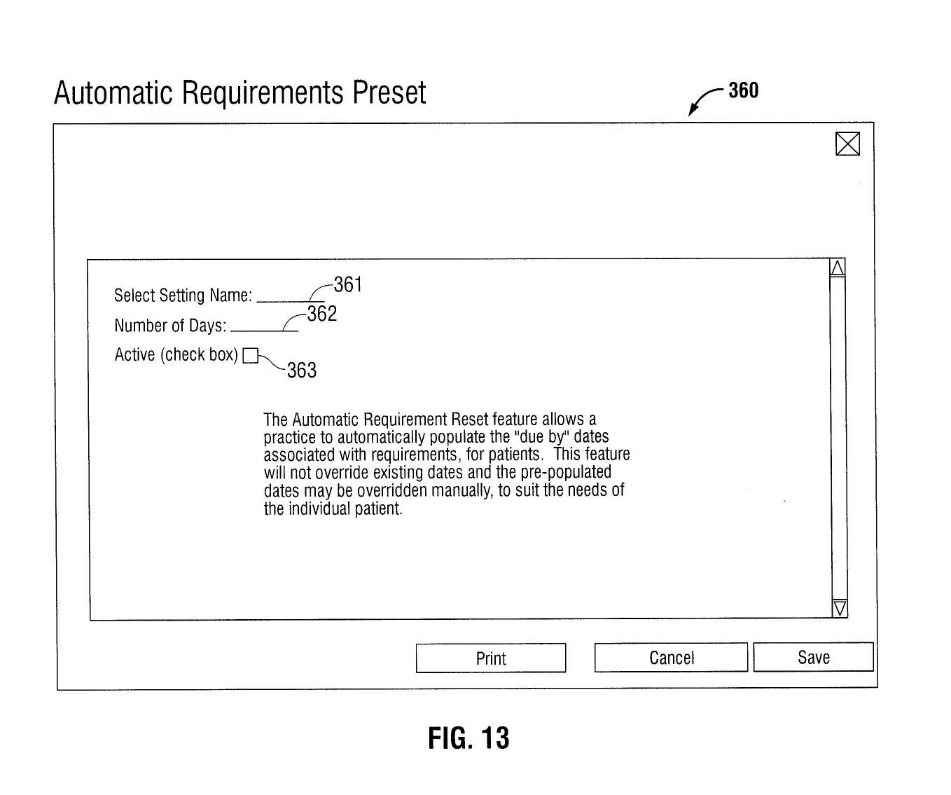

As shown in FIG. 13, a pre-surgical requirement reset page 360 is presented whereby the time period allotted to a patient (e.g., time window) for completion of a particular pre-surgical requirement may be specified. A requirement name 361 (e.g., “Nutritionist”) and a corresponding completion time period 362 (e.g., 1 week, 15 days, one month, etc.) may be entered. The corresponding pre-surgical requirement may also be activated/deactivated by checking/unchecking associated with the currently-specified requirement.

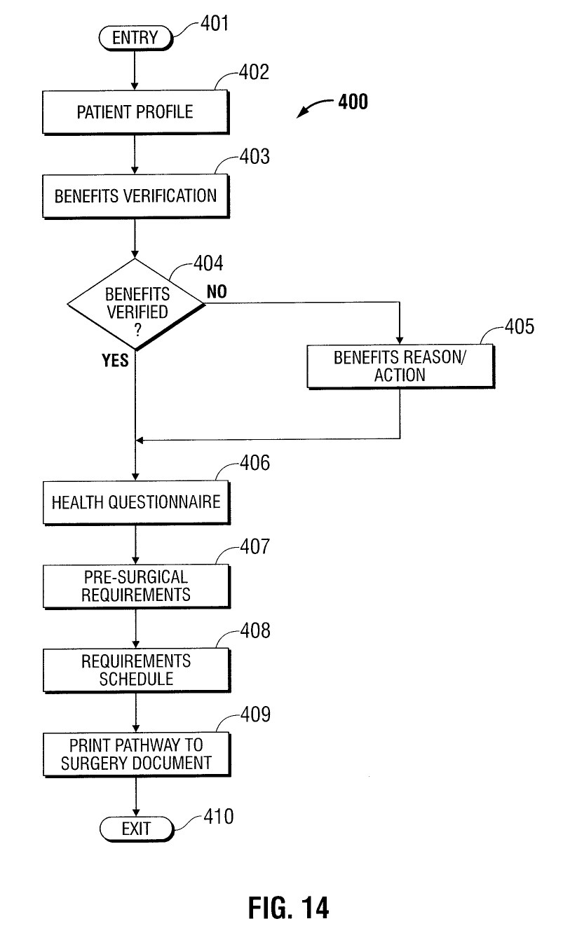

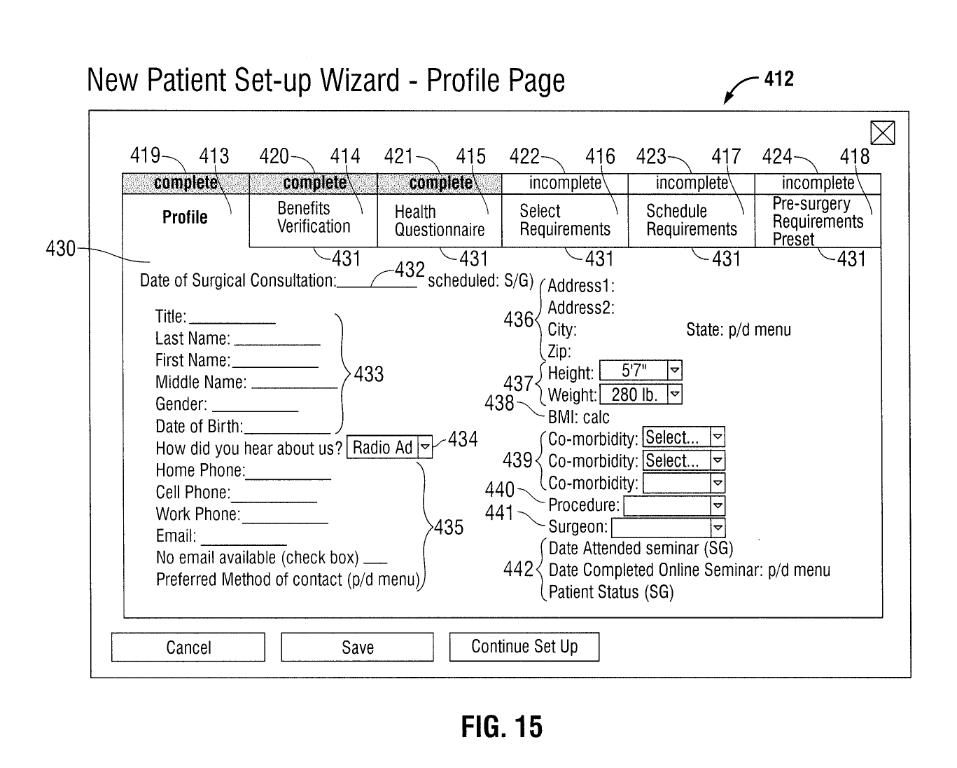

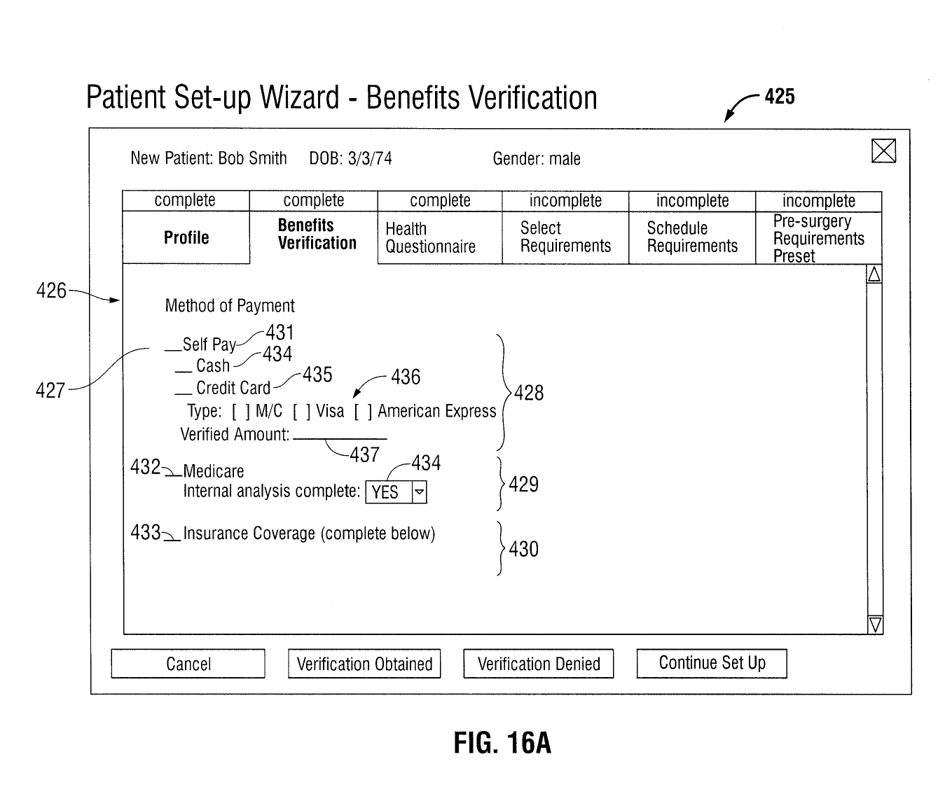

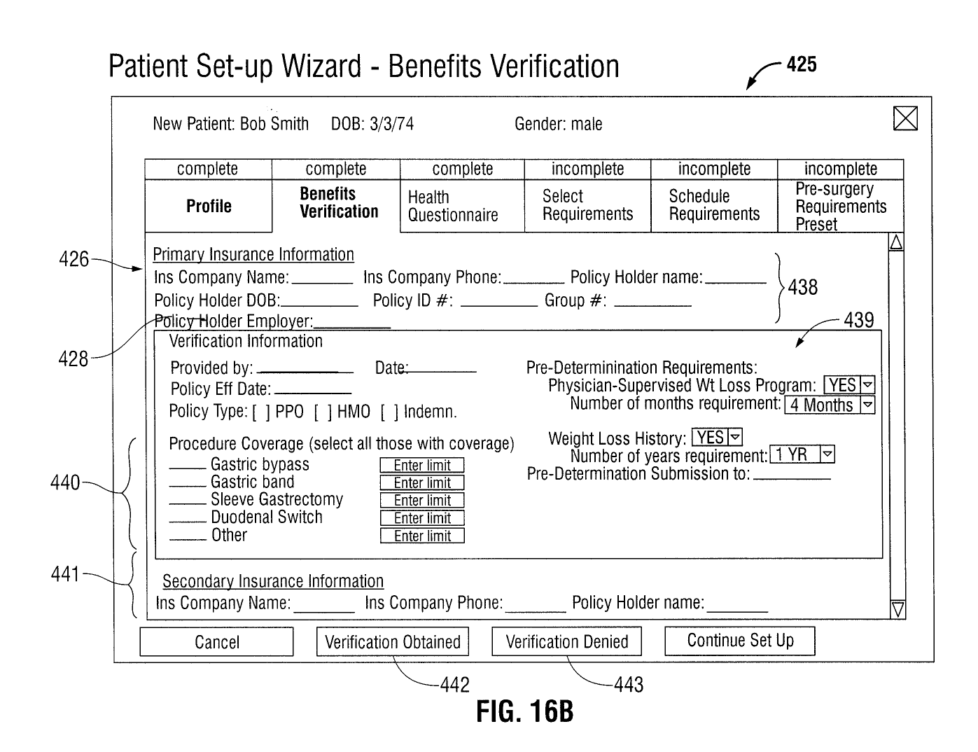

With reference to FIG. 14, patient module 400 is configured to facilitate the entry, by a user, of data relating to a patient of the practice. After completion of the initial entry of patient data, patient module 400 may be utilized by a user to perform ongoing maintenance (e.g., add, change, inquire, and delete) of patient data. Initially, an automated succession of pages may be presented to a user such that required patient information is accurately and completely captured. In the step 410, initial patient data entry is initiated whereupon in the step 402 patient profile data is entered via patient profile page 412 as illustrated in FIG. 15. Upon completion of patient profile page 412, in the step 403 a health benefits verification 425 presented as seen in FIGS. 16A and 16B. In the step 404 a determination is made whether a patient's health benefits page (e.g., health insurance coverage, self-pay information, etc.) have been verified. If in the step 404 it is determined that a patient's health benefits have not been verified, then the step 405 is performed wherein a benefit denial reason and follow-up action is recorded. In the step 406, answers to a patient's health questionnaire are recorded. In the step 407, a patient's pre-surgery requirements are established, whereupon in the step 408 the completion schedule for a patient's pre-surgery requirements is established. In the step 409, a Pathway To Surgery document is generated, which sets forth the patient's requirements which must be completed prior to surgery, as is described hereinbelow.

Patient profile page 412, as well as other patient pages described herein, includes one or more intelligent navigation tabs 413, 414, 415, 416, 417, and 418 which indicates a currently-displayed page (e.g., a page within the patient module 400 group), and/or, to enable a user to access other pages within a the group. As can be seen in FIG. 15, patient profile page 412 includes a patient profile tab 413, a benefits verification tab 414, a health questionnaire tab 415, a select requirements tab 416, a schedule requirements tab 417, and a pre-surgery requirements preset tab 418. Since patient profile page 412 is currently displayed, patient profile tab 413 is displayed contiguously with the page content region 430. In contrast, the remaining tabs (benefits verification tab 414, health questionnaire tab 415, select requirements tab 416, schedule requirements tab 417, and pre-surgery requirements preset tab 418) are discontiguously displayed, e.g., a dividing line 431 separates each tab from page content region 430. Each intelligent navigation tab 413-418 may include a status indication region 419 et seq. which provides a visual indication of whether the necessary data items corresponding with pages associated with each tab have been completed. By way of example, FIG. 15 shows that patient profile page tab 413, benefits verification page tab 414, and health questionnaire tab 415 indicate the data entry associated therewith have been completed, as illustrated by status indication regions 419, 420, and 421, respectively. In contrast, select requirements tab 416, schedule requirements tab 417, and pre-surgery requirements preset tab 418 each indicate the data entry associated therewith is incomplete, as reflected by status indication regions 422, 423, and 424, respectively.

Page content region 430 includes one or more data fields which relate to an individual patient of the practice. Certain fields may be pre-filled with a default value, a calculated value, or, may be selected from a predetermined list of values via, e.g., a drop down menu user interface element. Data fields of page content region 430 may include, without limitation, a date of surgical consultation 432, personal identification information 433 (e.g., first, last, and middle name, gender, date of birth), referrer information 434, contact information 435 (e.g., telephone and/or email addresses), residence information 436 (street addresses, city, state, zip), physical information 437 (height and weight), body mass index 438, co-morbidity conditions 439, bariatric procedure 440, surgeon 441, and patient status information 442 (e.g., date attended seminar, date completed online seminar, and patient status).

Referring to FIGS. 16A and 16B, a “benefits verification” page 425 includes a display region 426 in which various aspects (e.g., views) of benefits data may be displayed and/or edited. As seen in FIG. 16A, a first benefits view 427 is presented in display region 426 wherein at least one payment option is displayed. A self-pay option 428 is chosen by selecting a checkbox 431 corresponding thereto, which caused to be enabled a cash selection 434 and/or a credit card selection 435. Credit card selection 435 includes card type selector 436 (e.g., Mastercard®, VISA®, American Express®, etc.) and may include a verified amount 437 which may indicate a pre-authorized credit amount available to the patient. A Medicare option 429 may additionally or alternatively be chosen by selecting checkbox 432. An internal analysis indication 434 may be provided.

An insurance coverage option 430 may additionally or alternatively be chosen by selecting checkbox 433. As seen in FIG. 16B, a second benefits view 428 is presented in display region 426 wherein additional benefit information relating to insurance coverage may be entered and/or edited. Primary insurance carrier information 438 may include data field such as, without limitation, insurance company name, insurance company telephone number, policyholder name, policyholder date of birth, policy identification number, policy group identification number, and policyholder employer identification.

Insurance verification information 439 may include, without limitation, the party from whom insurance verification was provided, a verification date, a policy effective date, a policy type selection such as a whether the insurance carrier is a preferred provider organization (PPO), a health maintenance organizations (HMO), or an indemnity health plan. Coverage limits 440 for various procedures may additionally or alternatively be accommodated, e.g., coverage limits for gastric bypass, gastric band, sleeve gastrectomy, duodenal switch, and/or other bariatric procedures now or in the future known. Provider-imposed pre-determination requirements, if any, may be entered, such as without limitation requirements for a physician-supervised weight loss program, patient weight loss history, and pre-determination submission information. Additionally or alternatively, information relating to a secondary insurance carrier may be entered, e.g., secondary insurance carrier name, telephone number, and policyholder name.

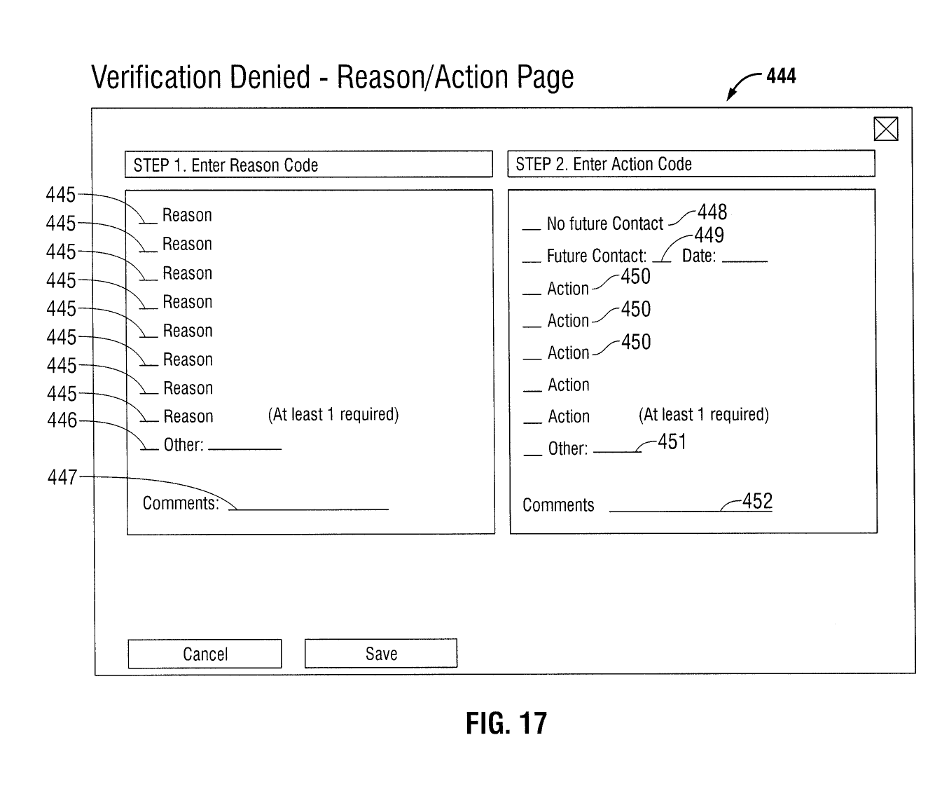

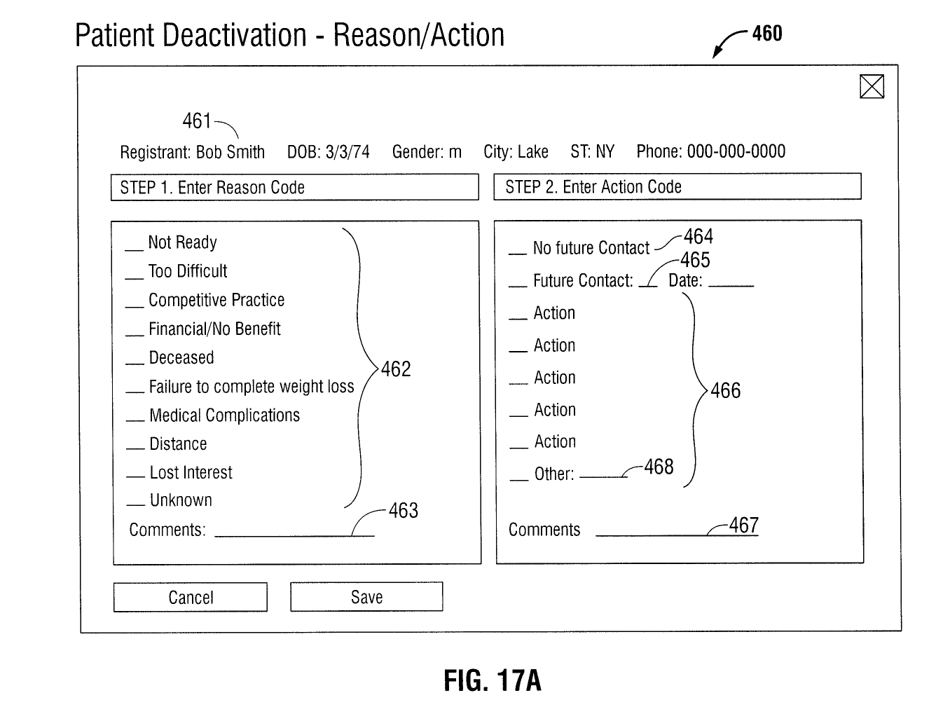

Verification information may be submitted to an insurance carrier manually by a user, or automatically by the disclosed system. Acknowledgement of successful verification of insurance and/or payor information may be indicated by a user actuating a “verification obtained” button 442. In contrast, if verification is not obtained, a “verification denied” button 443 may be actuated by the user. Upon actuation of the verification denied 443 button, and with reference to FIG. 17, a “verification denied-reason/action” page 444 may be presented to the user wherein at least one verification denied reason code 445 may be entered. A free-form “other reason” field 446 and/or reason denied comment field 447 may be provided. Additionally or alternatively, an action code 450 may be entered to schedule a follow-up action, if desired. A future contact date 449 may entered, or a “no future contact” checkbox 448 may be selected. A free-form “other action” field 451 and/or action comment field 452 may be provided.

In certain instances, a patient may be ineligible for treatment by a practice, or, may cease treatment prior to completion. Referring to FIG. 17A, a “patient deactivation” page 460 includes a patient selection field 461 which enables a user to specify a patient for deactivation. In an embodiment, patient selection field 461 is a predictive search field wherein, as a user inputs characters of the desired patient's name, a list of patients is presented which corresponds to the characters entered. In this manner a particular patient among many may be rapidly selected. Upon selection of the intended patient for deactivation, at least one reason code 462 may be selected by, e.g., activating a checkbox associated therewith. Additionally, free-form text comments may be entered in a comments field 463. An action code 466 may be entered to schedule a follow-up action, if desired. A future contact date 465 may entered, or a “no future contact” checkbox 464 may be selected. A free-form “other action” field 468 and/or free-form action comment field 467 may be provided.

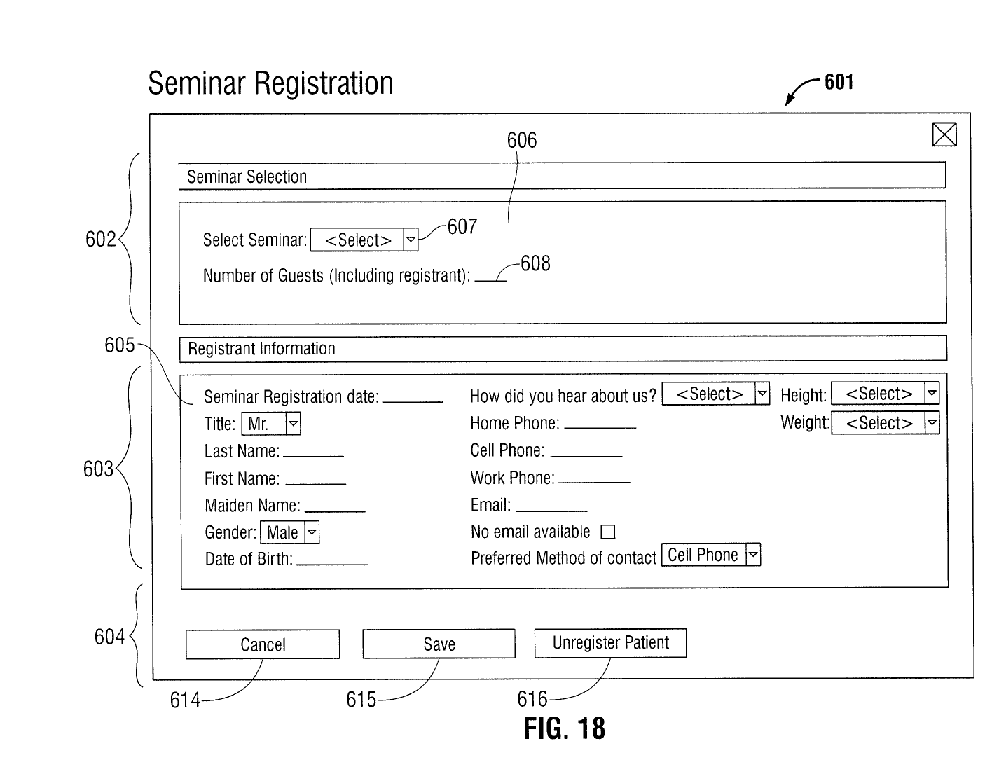

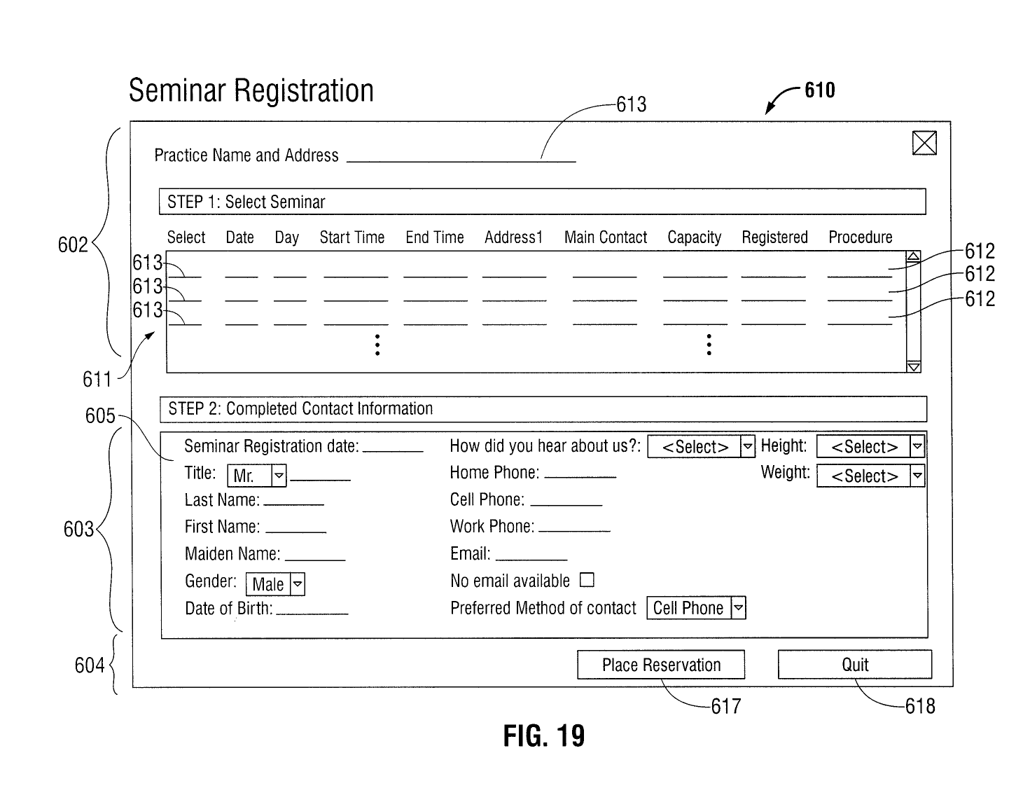

With reference to FIGS. 18 and 19, a seminar module 600 includes an “inward facing seminar registration” page 601 and an “outward-facing seminar registration page” 610 that are configured to enable a user to manage a seminar and attendance thereof. In an embodiment, seminar registration page 601 includes a seminar pane 602, a registrant pane 603, and a control page 604. The “inward facing” page 601, e.g., adapted for use by practice staff, is shown in FIG. 18 wherein seminar pane 602 includes inward-facing seminar selector 606. Inward-facing seminar selector 606 includes a select seminar field 607, which may be a pull-down menu that includes at least one seminar identifier, and a “number of guests” field 608 wherein the number of attendees (including the registrant-patient) under the present registration may be entered. An “outward facing” page 610, e.g., adapted for use by prospective and current patients, is shown in FIG. 19 wherein seminar pane 602 includes outward-facing seminar selector 611. Outward-facing seminar selector 611 includes a list of available seminars fields 612, which include, but are not limited to, seminar date and day, start and end times, address, a main contact (e.g., person or telephone number), seminar capacity, current number of registrants, and a seminar topic (e.g., which bariatric surgical procedure to be discussed). Additionally or alternatively, outward facing registration page 610 displays the practice name and address 613 in a top portion of the seminar pane 602.

Both “inward facing” seminar registration page 601 and “outward facing” seminar registration page 610 include registrant pane 603 having one or more data fields 605 relating to the nascent seminar registrant. Registrant data fields include a seminar registration date 605 (which may be computed or pre-filled based upon the seminar selected in seminar page 602), a registrant title or salutation (e.g., Mr., Mrs., Miss, Ms., etc.) which may be selected form a predetermined set of choices presented in a drop-down menu, the registrant's first, middle, and last name, gender, date of birth, referring entity, home telephone number, mobile telephone number, work telephone number, email address, communications preference (e.g., whether the registrant prefers a certain telephone number, or an email address, as a primary manner of communication), and physical characteristics (e.g., height and weight) of the registrant.

Control pane 604 of inward facing seminar registration page 601 includes a cancel button 614, a save button 615, and an unregister button 616. In use, actuating the cancel button 614 will discard any information that has been entered in seminar pane 602 and/or a registrant pane 603, and cause a home page to be displayed, as will be discussed below. Actuation of the save button 615 will commit any information that has been entered in seminar pane 602 and/or a registrant pane 603 to the disclosed system, and optionally, cause a home page to be displayed. Actuation of the unregister patient button 616 will unregister a previously saved registration, by, e.g., deleting information associated with the registration and/or retaining at least a part of the registration information and flagging the registration as “unregistered”.

Control pane 604 of outward-facing registration page 610 includes a “place reservation” button 617 and a quit button 618. During use, actuation of the place reservation button 617 will commit any information that has been entered in seminar pane 602 and/or a registrant pane 603 to the disclosed system. Actuating the quit button 6184 will discard any information that has been entered in seminar pane 602 and/or a registrant pane 603.

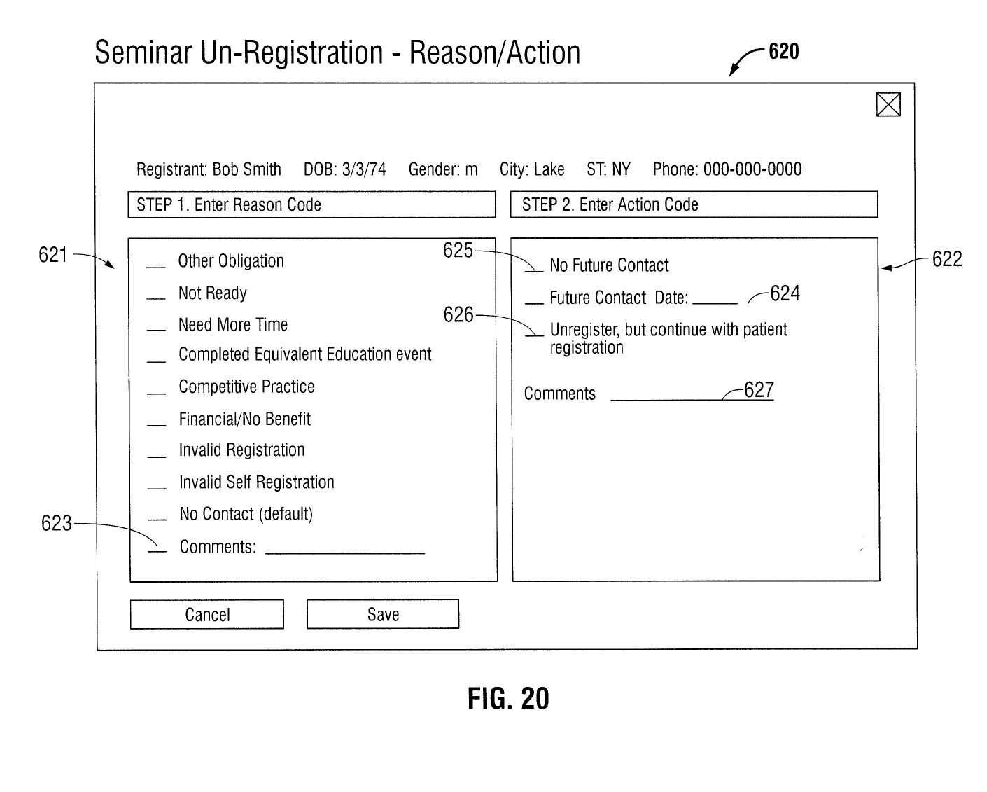

In the event of a seminar reservation cancellation, a seminar un-registration reason/action page 620 may be displayed. As shown in FIG. 20, a seminar un-registration reason/action page 620 in accordance with the disclosed system includes at least cancelation reason code 621 may be entered. A free-form “comments” field 623 may be provided. Additionally or alternatively, a future contact date 624 may entered, or a “no future contact” checkbox 625 may be selected. Optionally, a registrant's seminar reservation may be cancelled while retaining said registrant's information within the disclosed system for use, e.g., an a patient profile corresponding to the registrant by selection of checkbox 626. An action comments field 627 may additionally be provided to enable entry of a free-form text comment, as desired.

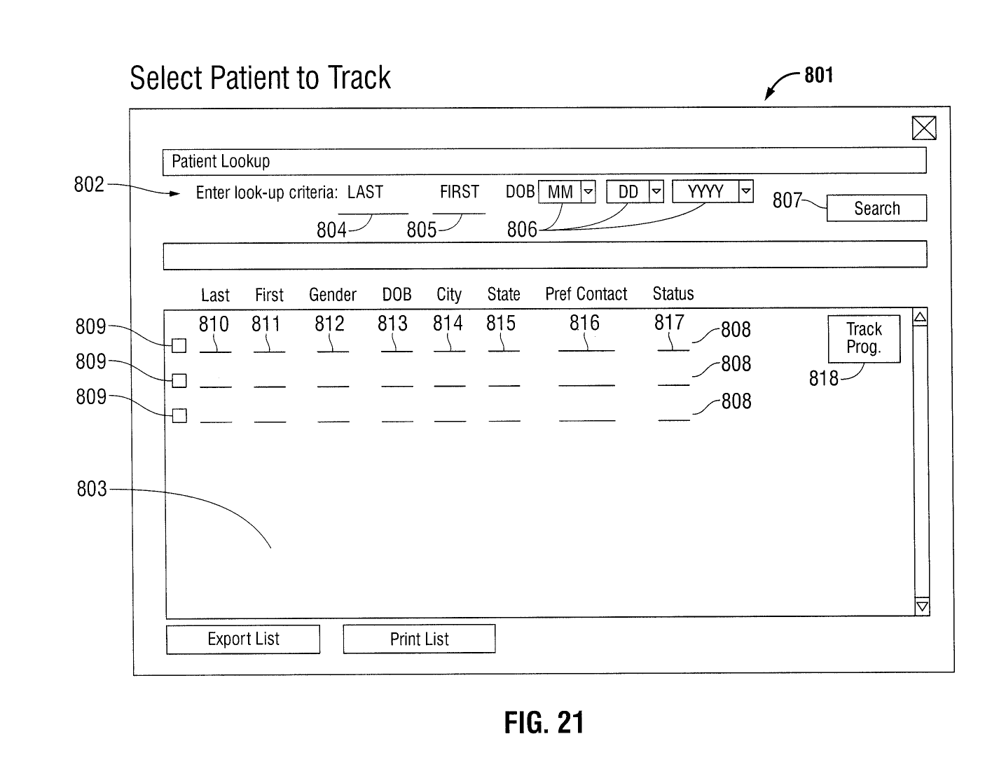

With reference to FIGS. 21, 22, and 23, the present disclosure is also directed to a tracking module 800 that is configured to enable tracking the progress of a subject patient though the pre-surgical and, additionally or alternatively, the post-surgical requirements related to a bariatric treatment plan. As seen in FIG. 21, a “select patient to track” page 801 is provided having a search region 802 and a list region 803. Search region 802 includes at least one patient selection field, e.g., patient last name search field 804, patient first name search field 805, and/or patient date of birth search field 806, which enables a user to specify a patient to track. In an embodiment, patient last name search field 804, patient first name search field 805, and/or patient date of birth search field 806 is a predictive search field wherein, as a user inputs characters of the desired patient's name, a list of patients is presented in patient list region 803 which corresponds to the characters entered. In another embodiment, at least one character may be entered into patient last name search field 804, patient first name search field 805, and/or patient date of birth search field 806 to specify patient search criteria. Upon entry of patient search criteria, a search button 807 may be actuated. In response, tracking module 800 identifies matching patients based upon the entered search criteria, and causes information related to the identified patients to be displayed as one or more matching patient lines 808 in list region 803. Such displayed patient information may include, but is not limited to, patient last name 810, patient first name 811, patient gender 812, patient date of birth 813, patient city and state 814 and 815, respectively, preferred contact 816 and patient status 817. A user may choose the intended subject patient from matching patient line 808 by activating a checkbox 809 corresponding thereto, and actuating a “track progress” button 818.

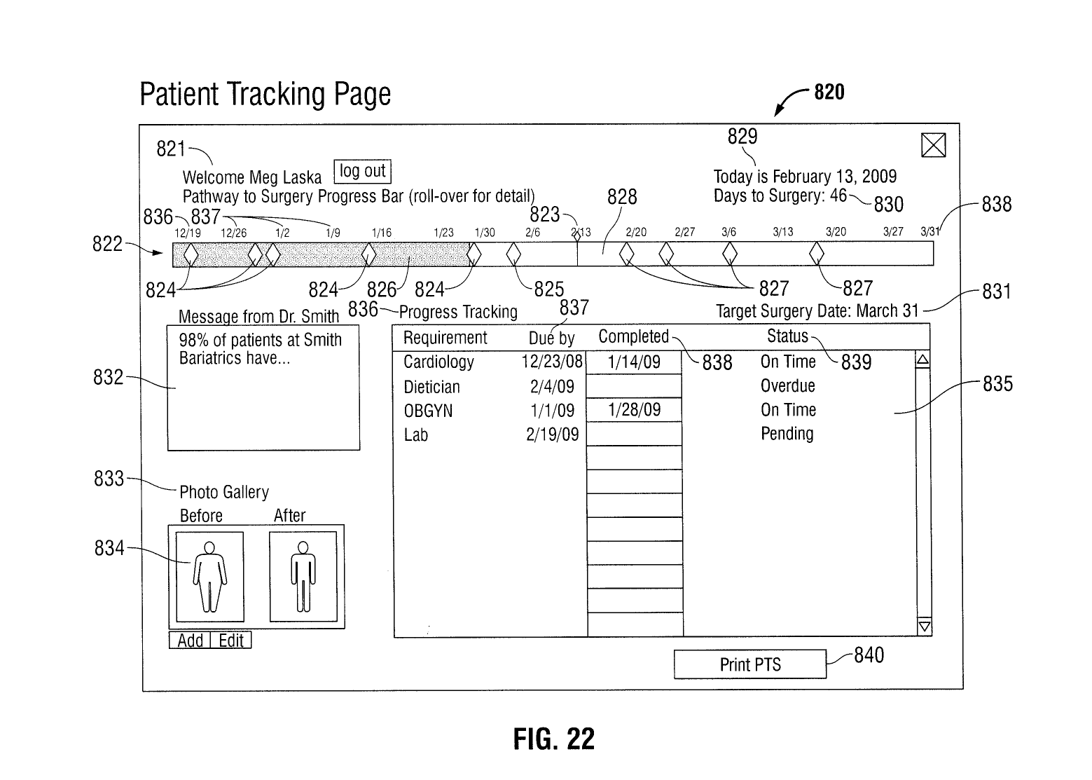

As seen in FIG. 22, a patient tracking page 820 includes a pathway to surgery progress bar 822 which graphically displays tracking information of a subject patient. In an embodiment, progress bar 822 displays a generally elongate rectangular timeline having, at an origin or leftmost end thereof, a start date indicator 836 corresponding to a date upon which an individual became a patient of the practice. Alternatively, start date indicator may correspond to a start-of-week date (e.g., a Sunday or Monday) of the week in which an individual became a patient of the practice. Progress bar 822 includes one or more interim date markers 827 which correspond to regular intervals, such as without limitation, succeeding weeks, following the start date. Progress bar 822 includes an end date 838 which corresponds to at date on which surgery is scheduled for a subject patient.

Progress bar 822 may include one or more graphical icons representative of tracking events. Tracking event icons include a scheduled (e.g., upcoming) requirement 827, a fulfilled (e.g., completed) requirement 824, a missed (e.g., overdue) requirement 825, and a current date indication 823. As seen in FIG. 22, each tracking icon type may exhibit a distinct appearance and/or color, which may enhance readability and/or visualization of a subject patient's tracking status. A shaded completion region 826 may be provided to indicate a portion of the timeline 822 beginning on or about the origin date thereof, continuing in a direction corresponding to an end date 838, and ending at a tracking icon representative of the most recently-completed (e.g., having the latest date) fulfilled requirement 824.

Patient tracking page 820 may display one or more tracking events in a progress list region 835. Progress list region may include at least one column relating to a subject patient's progress, including a scheduled requirement identification column 836, a due-by date (e.g., date by which the requirement is scheduled to be completed) 837, a completed date field 838 which indicates the date upon which the requirement was fulfilled, and a status column 839 which provides a succinct characterization of the current state of the requirement. For example, and without limitation, status column may indication whether the requirement was completed on-time, is overdue, or is pending (e.g., scheduled in the future). Additionally or alternatively, status column 839 may indicate whether a requirement is newly-added, changed, or canceled.

Patient tracking page 820 may include additional information relating to the subject patient. For example, and without limitation, a subject patient's name may be displayed as part of a welcome message 821. The current date 829 and/or a countdown indicator 830 showing the number of days remaining until the subject patient's surgery is scheduled may be displayed. A predetermined message 832 to the subject patient may be displayed, which may include a general announcement or marketing message (e.g., a “message of the day” or the like) and/or a personalized message intended for the subject patient. A patient photo gallery 833 may be provided which displays one or more images 834 (e.g., digital photographs) of the subject patient, such as, without limitation, a “before and after series” of the patient which, e.g., highlights the change in appearance of the patient throughout the treatment period.

Patient tracking page 820 may also include the ability to generate a Pathway to Surgery (PTS) document which includes one or more elements of patient tracking page 820. The PTS document may be generated in any suitable form, e.g., a hard-copy printout, a portable document format (PDF) file, a graphical format file such as a graphics interchange format (GIF) format, joint photographic experts group (JPEG) format, portable network graphics (PNG) format, and the like. A PTS document may be delivered to a subject patient via postal mail, email, and/or any other suitable means. Patient tracking page 820 may include a “Print PTS” button 840 to initiate generation and/or delivery of a Pathway to Surgery document to a patient, to a practice user or surgeon, and/or any other intended recipient.

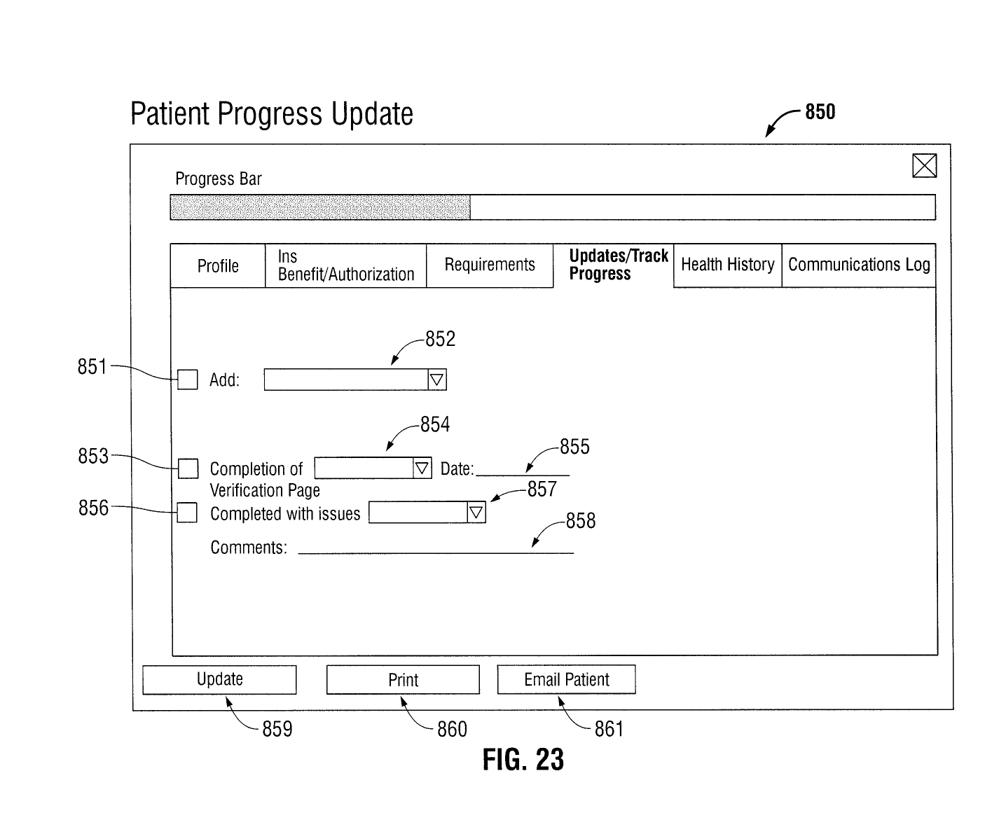

Turning to FIG. 23, a Patient Progress update page 850 is disclosed which enables the entry of data relating to additional and/or completed requirements with respect to a subject patient. A user may choose to add a requirement by enabling a checkbox 851 that corresponds to a selectable list 852 of additional requirements. Selectable list 852 may be any suitable user-interface element capable of presenting a list of requirements, such as without limitation a drop down menu. Additionally or alternatively, a user may indicate the completion of a requirement by enabling a checkbox 853 corresponding to a selectable list 854 of outstanding (e.g., assigned but not yet completed) requirements. A requirement completion date 855 field enables the entry of the requirement completion date, and may be pre-populated with a default date. The default date may correspond to the current date or any other intended date. In an embodiment, the default date may correspond to the most-recently entered completion date, which may be useful when entering a series of completed requirement from a single business date. In yet another embodiment, a completed requirement may be indicated by data transmission from the requirement specialist via, e.g., email, electronic data interchange (EDI), an extensible markup language (XML) file, or any other suitable data format. In certain instances, a requirement may be completed “with issues” or conditionally, which may be indicated by activation of the “completed with issues” checkbox 856. Additionally or alternatively, a selectable list of issues 857 may be provided from which a user may choose the appropriate issue, and/or a free-form issues comment field 858 may be provided in which a user may enter appropriate explanatory text.

A requirement that is completed with issues may necessitate repeating that particular requirement, and/or may indicate that one or more additional requirements must be scheduled for the patient. A Patient Progress update may be configured to automatically cause the recalculation of patient requirement due dates, and/or a scheduled surgery date, in response to a change in the progress of a patient. For example, a patient may have completed an unremarkable cardiac examination, but a related blood test may return results which indicate that a second (repeat) cardiac examination is medically advisable. The addition of a new, repeated, or additional requirement may therefore necessitate an adjustment to a scheduled target date for the remaining upcoming requirement, and/or, to the scheduled surgery date. In one embodiment, a Patient Progress update may automatically reschedule any outstanding (e.g., uncompleted) requirements and/or surgery date to accommodate the newly-added, repeated, or additional requirement. In an embodiment, the disclosed system includes a database of available surgery dates associated with the patient's designated surgeon, which may be accessed during a patient progress update to ascertain the next available surgery date and to modify patient requirements accordingly.

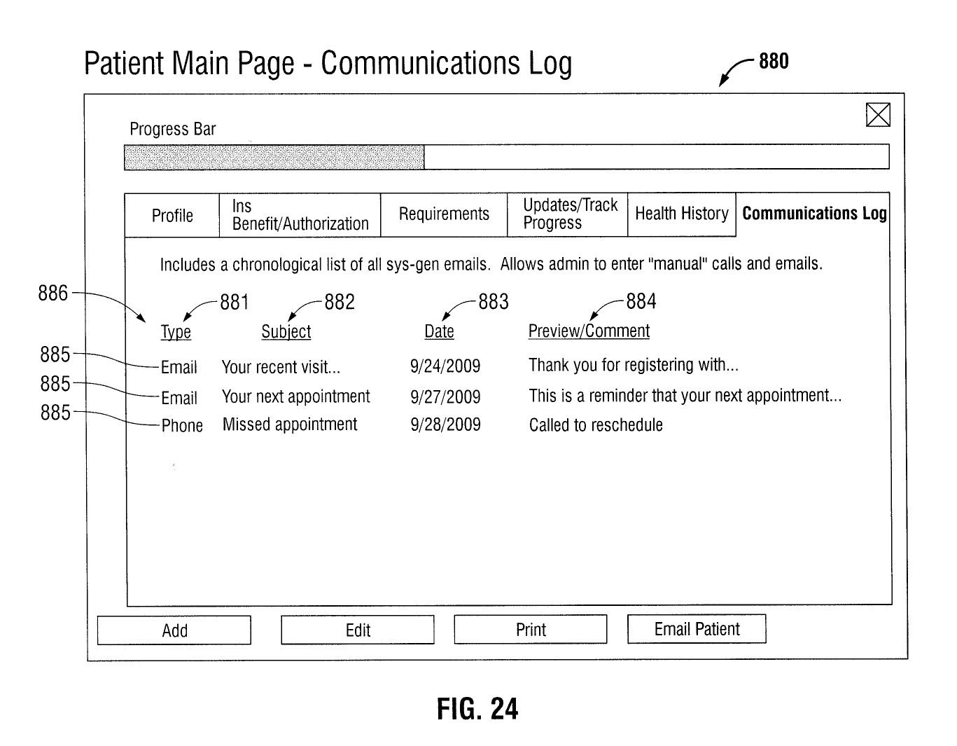

With reference to FIG. 24, a Communications Log page 880 is presented that includes a listing 886 of communications between the practice and a patient. As shown, the listing includes at least one row 885 that indicates a communication, which may include a communication type (e.g., email, telephone, SMS message, in-person contact, etc.), a communications subject, a communications date, and a communications summary and/or comment, which are arranged under respective column headers, e.g., communications type column header 881, a subject column header 882, a date column header 883 and/or a preview/comment header 884. Communications listing 886 may be initially presented in chronological order. Additionally or alternatively, communications listing 886 may be presented in alternative sort orders which may be selected by, e.g., clicking on the header to resort the list in accordance therewith. In an embodiment, a user may expand a row into a threaded view, which may chronologically present the listed communication, and any subsequent communications relating thereto (e.g., replies from the patient, follow-up emails, etc.)

With reference to Appendix B, a listing of sample communications, e.g., email messages and telephonic messages, that may be dispatched to patients, and a reason therefor (e.g., a “timing/trigger” event upon which the communication is occasioned) is shown. For example, and without limitation, such email messages may be dispatched in relation to a customer set-up and customer satisfaction (wherein a practice is regarded as a customer), emails to a professional network partner (e.g., a specialist), seminar registrant (e.g., prospective or actual patient) pre- and post-seminar communications, patient set-up communications, patient reminder and notification communications, dropped patient communications, and miscellaneous communications. Additionally or alternatively, various survey communications may be dispatched, as shown in Appendix B, page 3.

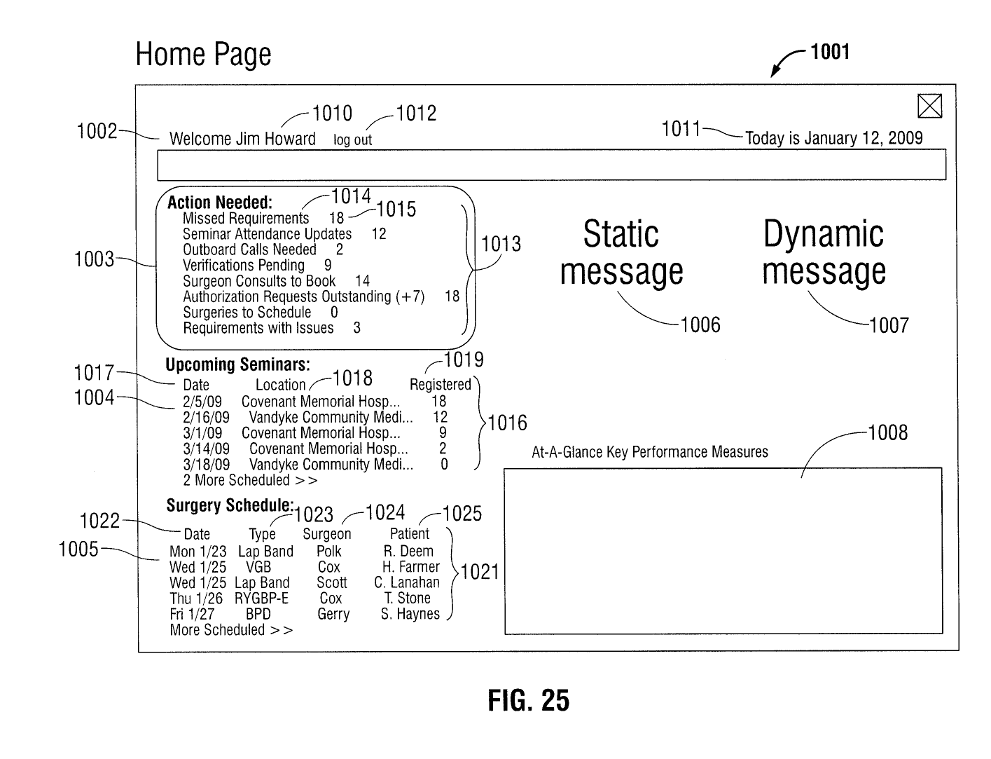

Referring now to FIG. 25, the present disclosure is also directed to an executive module 1000 which is configured to provide a Home Page 1001, and may additionally or alternatively provide navigation functions within the user interface, and/or housekeeping functions with respect to system-level options, such as without limitation, printer setup, end-user license agreement notification and acceptance, network setup, and the like. Upon authenticating to the system (e.g., logging into the system by supplying a user name and a password), a user may be presented with Home Page 1001. Home Page 1001 may include a number of panes, e.g., salutation pane 1002, action item page 1003, upcoming seminar pane 1004, surgery schedule pane 1005, static message pane 1006, dynamic message pane 1007, and/or at-a-glance pane 1008. In greater detail, salutation pane 1002 may include a welcome message featuring the user's name 1010, the current date, and optionally or alternatively, the current time 1011, and a “log out” user interface item configured to end the current authentication session.

Action item pane 1003 may include a summary list of outstanding task items 1013 which are slated to be addressed by the practice staff. In an embodiment, the action item pane 1003 may include task items 1013 that are the specific responsibility of the logged-in user, task items 1013 that are of general responsibility to the practice as a whole, or a combination thereof. A task item 1013 may include a task type 1014 and a task count 1015 that indicates the number of pending tasks within a task type. Task items 1013 may include a user interface element (e.g., a clickable link) which may cause to be presented to the user a detail page (not explicitly shown) wherein individual component tasks of the task item summary 1013 may be viewed and/or acted upon.

Upcoming seminar pane 1004 may include a summary list of seminars 1016 that are currently scheduled to be presented. Summary list of seminars 1016 includes the seminar date 1017 and location 1018, and may include the number of presently-registered attendees for each respective seminar. As shown, an additional seminar user interface element 1020 may optionally be presented if the number of scheduled seminars exceeds a pre-set number, which, when clicked, may display the additional seminar listings accordingly. Additionally, each seminar summary 1016 may include a user interface element (e.g., a clickable link) which may cause to be presented to the user a detail page (not explicitly shown) wherein individual seminar information, (e.g., rosters, registrants, location and other seminar attributes) may be viewed and/or modified.

Surgery schedule pane 1005 may include a list of surgeries 1021 that are currently scheduled. Summary list of seminars 1021 includes the surgery date 1022 (and optionally, surgery time), surgery type 1023, assigned surgeon 1024, and patient name 1025. As shown, an additional surgery user interface element 1026 may optionally be presented if the number of scheduled surgeries exceeds a pre-set number, which, when clicked, may display the additional surgery listings accordingly. Additionally, each surgery listing 1021 may include a user interface element (e.g., a clickable link) which may cause to be presented to the user a detail page (not explicitly shown) wherein individual surgery information may be viewed and/or modified.

Home Page 1001 may also include a static message pane 1006, dynamic message pane 1007, and/or an at-a-glance pane 1008. Static message pane 1006 may include a text message or graphic element (e.g., photograph, animation and/or video clip) that is generally unchanging in nature. By way of example only, a static message may include a practice logo, motto, and/or contact information. Dynamic message pane 1007 may include a text message or graphic element which may be dynamically generated, e.g., about when the Home Page 1001 is initially presented and/or dynamically updated thereafter. By way of example, message pane 1007 may include one of a plurality of rotating “messages of the day”, a notification of an upcoming staff meeting, and/or a security camera video feed. At-a-glance pane 1008 may include a listing of one or more performance metrics relating to the practice, including without limitation, changes in performance metrics between a current business reporting period versus a prior reporting period (e.g., current quarter versus prior quarter, this year versus last year, and the like). For example, and without limitation, at-a-glance pane 1008 may include statistics relating to the number of seminars conducted, number of seminar registrants, conversion rates, surgeries completed, and the like.

It will be appreciated that variations of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. Therefore, the herein description should not be construed as limiting, but merely as exemplifications of particular embodiments. The claims can encompass embodiments in hardware, software, or a combination thereof.

What is claimed is:

1. A computer-implemented method for managing a medical practice, comprising:
establishing a practice profile wherein the practice profile includes at least one of an administrative parameter, a patient requirement parameter, and a surgeon identifier;
establishing at least one patient profile corresponding to a patient, wherein the patient profile includes at least one of a patient identifier, a patient requirement parameter, a patient requirement parameter due date, and a surgery identifier;
receiving a patient requirement completion date;
comparing the patient requirement parameter due date to the patient requirement completion date;
generating automatically a pathway to surgery document that includes the patient requirement parameter due date and the patient requirement completion date; and
causing to be delivered to the patient the pathway to surgery document.

2. The computer-implemented method in accordance with claim 1, wherein the surgery identifier includes at least one of a surgical procedure type or a surgical procedure date.

3. The computer-implemented method in accordance with claim 1, wherein the pathway to surgery document is generated in a digital document format.

4. The computer-implemented method in accordance with claim 4, wherein the digital document format is selected from the group consisting of portable document format, graphics interchange format, joint photographic experts group format, a markup language format, and portable network graphics format.

5. The computer-implemented method in accordance with claim 1, further comprising:
displaying at least a portion of a patient profile in a graphical display, wherein the graphical display includes a tabbed region, the tabbed region including a label region adapted to display fixed information and a status region adapted to display variable information.

6. The computer-implemented method in accordance with claim 1, wherein the pathway to surgery document is printed on a printing device selected from the group consisting of a toner-based printer, an inkjet-based printer, an impact printer, and a thermal printer.

7. The computer-implemented method in accordance with claim 1, wherein the pathway to surgery document includes a timeline having at least one icon representative of a patient requirement parameter completion date.

8. The computer-implemented method in accordance with claim 1, further comprising:
receiving data identifying at least one potential professional network affiliate, wherein the potential professional network affiliate identifying data includes an email address and a status flag having an initial inactive state;
causing an invitational email to be dispatched to the potential professional network affiliate, wherein the email includes an invitation to the potential professional network affiliate to join a professional network of the medical practice.

9. The computer-implemented method in accordance with claim 8, further comprising:
receiving an email responsive to the invitational email from the potential professional network affiliate;
determining whether the response of the potential professional network is an affirmative response; and
indicating receipt of an affirmative response by activating the status flag corresponding to the potential professional network affiliate to indicate the potential professional network affiliate is an active professional network affiliate.

10. The computer-implemented method in accordance with claim 8, further comprising associating at least one specialist with the potential professional network affiliate.

11. A computer-implemented medical practice management system, comprising:
at least one processor operatively coupled to a storage device;
a data interface operatively coupled to the processor and adapted to receive a user input from an access device;
a practice module operatively coupled to the processor and configured to receive, store, and display information relating to a practice profile, wherein the practice profile includes at least one preset patient requirement;
a patient module operatively coupled to the processor and configured to receive, store, and display information relating to a patient profile, wherein the patient profile includes at least one patient requirement and a corresponding patient requirement due date;
a tracking module operatively coupled to the processor and configured to compare the patient requirement due date to at least one of a patient requirement completion date or a current date, and to generate a pathway to surgery document based thereupon.

12. The computer-implemented medical practice management system of claim 11, wherein the pathway to surgery document is generated in a format selected from the group consisting of portable document format, graphics interchange format, joint photographic experts group format, a markup language format, and portable network graphics format.

13. The computer-implemented medical practice management system of claim 11, further comprising a seminar module operatively coupled to the processor and configured to receive at least one seminar schedule and to record at least one scheduled attendee thereof.

14. The computer-implemented medical practice management system of claim 13, wherein the seminar module is further configured to cause to be sent a seminar survey to the at least one scheduled attendee.

15. The computer-implemented medical practice management system of claim 11, wherein the patient profile further includes a surgical procedure identifier, a surgeon identifier, and a surgery date.

16. Computer-readable media comprising a set of executable instructions for performing a method for managing a medical practice, the method comprising:
establishing a practice profile wherein the practice profile includes at least one of an administrative parameter, a patient requirement parameter, and a surgeon identifier;
establishing at least one patient profile corresponding to a patient, wherein the patient profile includes at least one of a patient identifier, a patient requirement parameter, a patient requirement parameter due date, and a surgery identifier;
receiving a patient requirement completion date;
comparing the patient requirement parameter due date to the patient requirement completion date;
generating automatically a pathway to surgery document that includes the patient requirement parameter due date and the patient requirement completion date; and
causing to be delivered to the patient the pathway to surgery document.

17. The computer-readable media in accordance with claim 16, wherein the surgery identifier includes at least one of a surgical procedure type or a surgical procedure date.

18. The computer-readable media in accordance with claim 16, wherein the pathway to surgery document is generated in a digital document format.

19. The computer-readable media in accordance with claim 18, wherein the digital document format is selected from the group consisting of portable document format, graphics interchange format, joint photographic experts group format, a markup language format, and portable network graphics format.

20. The computer-readable media in accordance with claim 16, further comprising:
displaying at least a portion of a patient profile in a graphical display, wherein the graphical display includes a tabbed region, the tabbed region including a label region adapted to display fixed information and a status region adapted to display variable information.
